(19) United States
(12) Patent Application Publication
(10) Pub. No.: US 2016/0183340 A1
(43) Pub. Date: Jun. 23, 2016

(54) LED DRIVING INTEGRATED CIRCUIT AND DRIVING METHOD THEREFOR

(71) Applicant: LECORE TECHNOLOGIES INC., Seoul (KR)

(72) Inventors: Yong Hee LEE, Seongnam-si (KR); Mueng Yul LEE, Seoul (KR); Yoo Chang SUNG, Hwaseong-si (KR)

(21) Appl. No.: 14/909,631

(22) PCT Filed: Jul. 29, 2014
(86) PCT No.: PCT/KR2014/006954

§ 371 Date: Feb. 2, 2016

(30) Foreign Application Priority Data
Aug. 2, 2013 (KR) 10-2013-0092261
Apr. 29, 2014 (KR) 10-2014-0051669

(51) Int. Cl. H05B 33/08

(52) U.S. Cl. CPC H05B 33/0845; H05B 33/083; H05B 33/0809

(57) ABSTRACT

Disclosed are an LED driving integrated circuit and a driving method therefor. The LED driving integrated circuit of the present invention relates to a multi-channel AC direct-type LED driving circuit, comprising: an LED array comprising first to k-th (an integer not less than 2) LED groups connected in series; a control unit comprising a plurality of (not less than 2) switches connected to the LED array and a switch control circuit for selectively opening and closing the switches; and a valley-fill circuit, which receives the rectified voltage of an alternating current (AC) voltage, for supplying first and second variant rectified voltages to the LED array. The valley fill circuit supplies the first variant rectified voltage to an input of the first LED group of the LED array, and supplies the second variant rectified voltage to any one of the inputs of the remaining LED groups except the first LED group.

### TECHNICAL FIELD

The present invention relates to a light driving circuit and method, and more particularly, to a light emitting diode (LED) driving integrated circuit and method for driving LED lighting.

### BACKGROUND ART

It is a recent trend to introduce light sources using a light emitting diode (LED) more efficient than other existing light sources as one of the measures for saving energy.

Methods of driving LED lighting are largely divided into alternating current (AC)-direct current (DC) conversion methods of converting AC power into DC power and driving an LED using the DC power and AC direct methods of directly driving an LED using AC power without converting AC power into DC power.

A flicker index is one of the quality factors of LED lighting. The flicker index is a figure indicating the intensity of flicker in LED lighting. It is necessary to reduce the flicker in order to increase the quality of LED lighting.

In conventional incandescent lighting, a brightness controller (e.g., a device for controlling brightness using a rotary switch) is used to control the brightness of an incandescent light bulb. Therefore, a device for controlling the brightness of LED lighting is desired.

### DETAILED DESCRIPTION OF THE INVENTION

### Technical Goal of the Invention

The present invention provides an alternating current (AC) direct type light emitting diode (LED) driving circuit for reducing flicker in LED lighting.

The present invention also provides an AC direct type LED driving circuit for detecting a phase cut rate of AC power in a brightness controller and controlling the brightness of LED lighting.

### Technical Solutions of the Invention

According to an aspect of the present invention, there is provided an alternating current (AC) direct type light emitting diode (LED) driving circuit including an LED array including first through k-th LED groups connected in series, where “k” is an integer of at least 2; a control unit including a plurality of switches connected to the LED array and a switch control circuit which selectively closes or opens the switches; and a valley-fill circuit configured to receive a rectified voltage of an AC voltage and to supply a first transformed rectified voltage and a second transformed rectified voltage to the LED array.

The valley-fill circuit provides the first transformed rectified voltage for an input of the first LED group and provides the second transformed rectified voltage for an input of one of the LED groups except for the first LED group. Each of the first through k-th LED groups includes at least one LED. When at least two LEDs are included in one LED group, the at least two LEDs are connected in series, in parallel, or in a combination of series and parallel.

The valley-fill circuit may include a first capacitor connected between a first node and a second node, a first diode connected between the second node and a third node, a second capacitor connected between the third node and a ground, a second diode connected between the ground and the second node, and a third diode connected between the third node and a fourth node.

The first node may be connected to the input of the first LED group and the fourth node may be connected to an input of a j-th LED group among the first through k-th LED groups, where “j” is an integer of at least 2 and at most “k”.

The first transformed rectified voltage may be a voltage of the first node and the second transformed rectified voltage may be a voltage of the fourth node.

The LED array may further include a diode connected between the input of the j-th LED group and an output of a (j−1)-th LED group.

The valley-fill circuit may further include a resistor connected between the first capacitor and the second capacitor.

The plurality of switches may include first through m-th switches, where “m” is an integer of at least 2. The switch control circuit may selectively close or open each of the first through m-th switches.

The control unit may control brightness of the LED array by controlling current flowing in each of the first through m-th switches.

Here, “m” is equal to or less than “k”.

The switch control circuit may generate a control signal to allow current to flow from the first node to the first through (j−1)-th LED groups and simultaneously from the fourth node to the j-th through k-th LED groups in a valley period.

According to another aspect of the present invention, there is provided an AC direct type LED driving circuit including an LED array which includes first through n-th LED groups connected in series and operates using a phase-cut AC voltage, where “n” is an integer of at least 2; and a control unit connected with the LED array.

The control unit includes a multichannel switch circuit including first though m-th switches connected with the LED array, where “m” is an integer of at least 2; a multichannel switch control circuit configured to selectively close or open each of the first through m-th switches; a phase detector configured to receive the phase-cut rectified voltage, detect duty information indicating a phase-cut rate, and generate a duty detection signal; a phase dimming controller configured to generate a dimming reference voltage in response to the duty detection signal; and an analog dimming unit configured to control brightness of the LED array by controlling current flowing in each of the first through m-th switches based on the dimming reference voltage.

The control unit may further include a bleeder circuit configured to allow holding current, which is necessary for an operation of a phase-cut dimmer generating the phase-cut AC voltage, to flow.

The phase detector may include a comparator configured to compare a comparison target voltage with a comparison reference voltage to generate the duty detection signal. The comparison target voltage may be based on the phase-cut rectified voltage.

The phase detector may include a Schmidt trigger configured to receive a comparison target voltage and generate the duty detection signal. The comparison target voltage may be based on the phase-cut rectified voltage.

The phase detector may include a resistor and a Zener diode connected in series between a ground and a node to which the phase-cut rectified voltage is input.

The phase dimming controller may include a multiplexer configured to multiplex a first reference voltage and a second reference voltage in response to the duty detection signal and a low-pass filter configured to perform low-pass filtering on an output of the multiplexer to output the dimming reference voltage.

The phase dimming controller may include a multiplexer configured to multiplex a first reference voltage and a second reference voltage in response to the duty detection signal, a sampling switch connected to an output of the multiplexer to be opened or closed in response to a sampling clock signal, and a low-pass filter configured to perform low-pass filtering on an output of the sampling switch to output the dimming reference voltage.

The phase dimming controller may generate an N-bit digital code varying with the duty detection signal and may convert the digital code into an analog voltage to generate the dimming reference voltage.

The LED driving circuit may further include a rectifier configured to generate a rectified voltage of the phase-cut AC voltage, a diode connected to the rectifier, and a valley-fill circuit connected between the diode and the LED array to supply a transformed rectified voltage to the LED array.

The transformed rectified voltage may include a first transformed rectified voltage and a second transformed rectified voltage. The valley-fill circuit may supply the first transformed rectified voltage to an input of the first LED group of the LED array and the second transformed rectified voltage to an input of one of the LED groups except for the first LED group.

The valley-fill circuit may include a first capacitor connected between a first node and a second node, a first diode connected between the second node and a third node, a second capacitor connected between the third node and a ground, a second diode connected between the ground and the second node, and a third diode connected between the third node and a fourth node. The first node may be connected to the input of the first LED group. The fourth node may be connected to an input of a j-th LED group among the first through k-th LED groups, where “k” is an integer of at least 2 and “j” is an integer of at least 2 and at most “k”. The LED array may further include a diode connected between the input of the j-th LED group and an output of a (j−1)-th LED group.

According to a further aspect of the present invention, there is provided an AC direct type LED driving circuit including an LED array including first through k-th LED groups connected in series, where “k” is an integer of at least 2; a control unit including a plurality of switches connected to the LED array and a switch control circuit which selectively closes or opens the switches; and a switchable fill circuit configured to receive a rectified voltage of an AC voltage and to supply a current to the LED array.

The switchable fill circuit may provide a first input current for an input of the first LED group of the LED array in a first period and may provide a second input current for the input of the first LED group of the LED array and a third input current for an input of one of the LED groups except for the first LED group in a second period.

The LED driving circuit may further include a switchable fill control circuit configured to control the switchable fill circuit to operate differently in the first period and the second period.

The switchable fill circuit may include a resistor connected between a first node and a second node, a capacitor connected between the second node and a ground, a transistor connected between the second node and a third node and connected to the switchable fill control circuit, a first diode connected in parallel with the resistor, and a second diode connected between the third node and a fourth node. The first node may be connected to the input of the first LED group and the fourth node may be connected to an input of a j-th LED group.

The switchable fill control circuit may turn off the transistor in the first period and may turn on the transistor in the second period.

### Effect of the Invention

According to the present invention, the flicker of light emitting diode (LED) lighting is reduced.

In addition, a phase-cut rate of a brightness controller for an alternating current (AC) power is detected, so that the brightness of LED lighting can be controlled. In particular, an AC power phase-cut rate of a brightness controller (e.g., a rotary switch) used for existing incandescent light is detected to control the brightness of LED lighting, so that the present invention is compatible with existing brightness controllers.

### BRIEF DESCRIPTION OF THE DRAWINGS

The brief description of the drawing is provided for sufficient understanding of the attached drawings referred to in the detailed description of the present invention.

FIG. 1 is a schematic block diagram of a light emitting diode (LED) driving circuit according to the present invention.

FIG. 2 is a circuit diagram of a filter/rectifier, a valley-fill circuit, and an LED array illustrated in FIG. 1 according to an embodiment of the present invention.

FIG. 3 is a schematic diagram of the waveforms of a rectified voltage and a first transformed rectified voltage output from a valley-fill circuit in an embodiment of the present invention.

FIG. 4 illustrates LED luminance when a valley-fill circuit does not exist.

FIG. 5 illustrates LED luminance when a valley-fill circuit exists.

FIG. 6 illustrates the voltage/current waveform of an AC power.

FIGS. 7 through 10 are circuit diagrams of the modifications of a valley-fill circuit, an LED array, and a multichannel switch circuit according to embodiments of the present invention.

FIGS. 11 and 12 are schematic block diagrams of LED driving circuits according to other embodiments of the present invention.

FIGS. 13 and 14 are block diagrams of the modifications of the LED driving circuits respectively illustrated in FIGS. 11 and 12.

FIG. 15 illustrates voltage waveforms of a rectified voltage according to various embodiments of the present invention.

FIG. 16 illustrates current waveforms of an LED current according to various embodiments of the present invention.

FIG. 17 is a circuit diagram of a phase detector according to an embodiment of the present invention.

FIG. 18 is a circuit diagram of a phase detector according to another embodiment of the present invention.

FIG. 19 is a circuit diagram of a phase detector according to a further embodiment of the present invention.

FIG. 20 is a circuit diagram of a phase dimming controller according to an embodiment of the present invention.

FIG. 21 is a circuit diagram of a phase dimming controller according to another embodiment of the present invention.

FIG. 22 illustrates the waveforms of a duty detection signal and a sampling clock signal according to an embodiment of the present invention.

FIG. 23 is a circuit diagram of a phase dimming controller according to a further embodiment of the present invention.

FIG. 24 is a schematic block diagram of an LED driving circuit according to still another embodiment of the present invention.

FIG. 25 is a block diagram of the modification of the LED driving circuit illustrated in FIG. 24.

FIGS. 26 and 27 are graphs showing a dimming profile according to embodiments of the present invention.

FIG. 28 is a schematic block diagram of an LED driving circuit according to a further embodiment of the present invention.

FIG. 29 is a circuit diagram of a filter/rectifier, a switchable fill circuit, a multichannel switch, and an LED array illustrated in FIG. 28 according to an embodiment of the present invention.

FIG. 30 is a circuit diagram for explaining the operation of the LED driving circuit illustrated in FIG. 29 during period 1.

FIG. 31 is a schematic waveform diagram for explaining the operation of the LED driving circuit illustrated in FIG. 29 during period 1.

FIG. 32 is a circuit diagram for explaining the operation of the LED driving circuit illustrated in FIG. 29 during period 2.

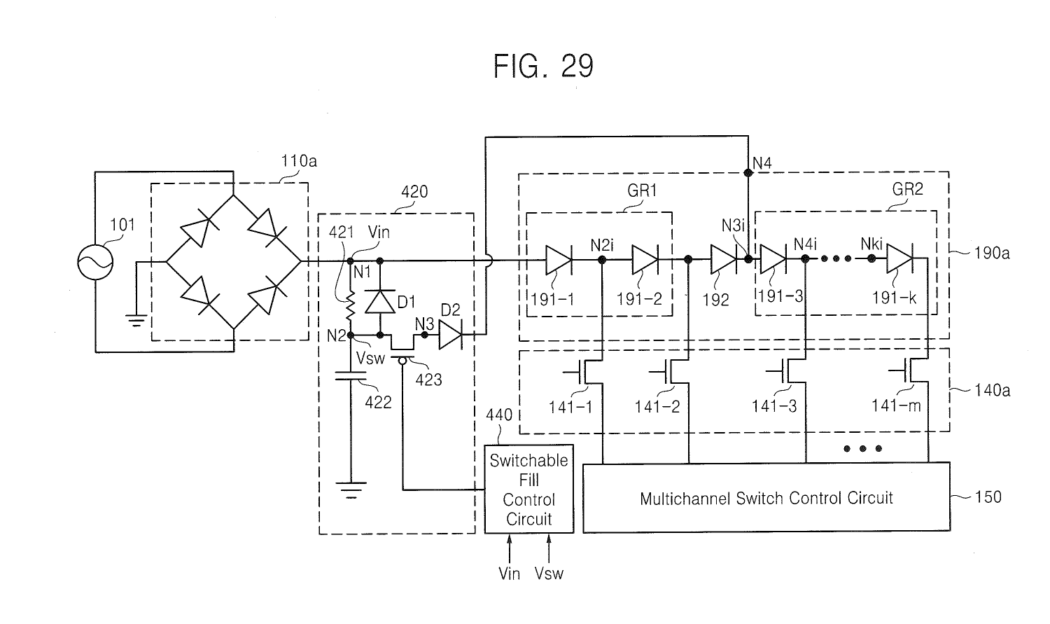

FIG. 31 is a schematic waveform diagram for explaining the operation of the LED driving circuit illustrated in FIG. 29 during period 2.

FIG. 34 is a schematic waveform diagram of LED input voltage and current in a conventional AC direct type LED driving circuit.

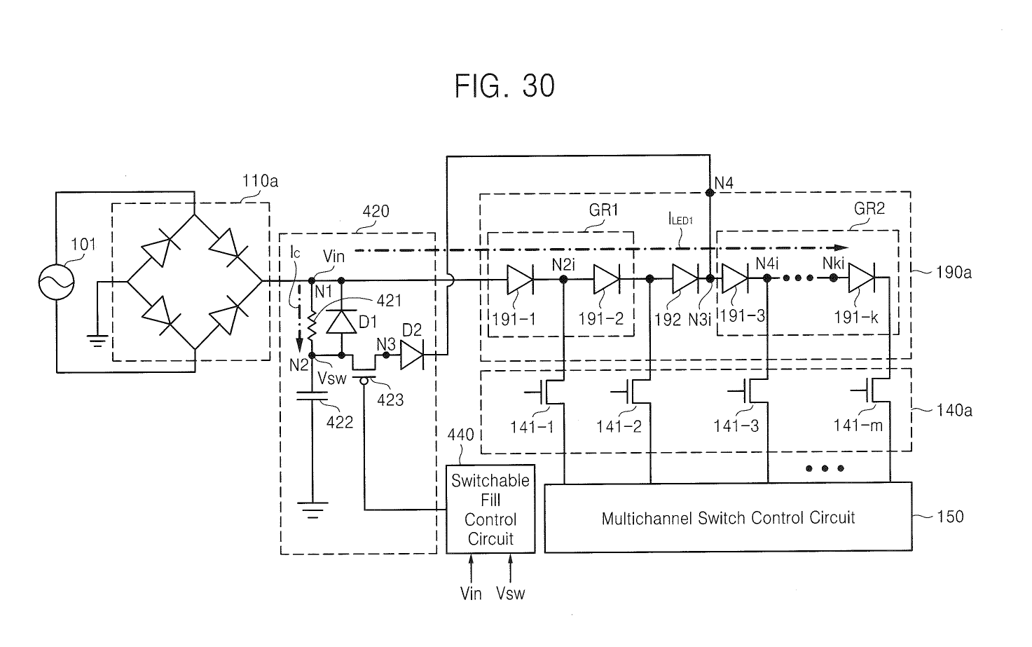

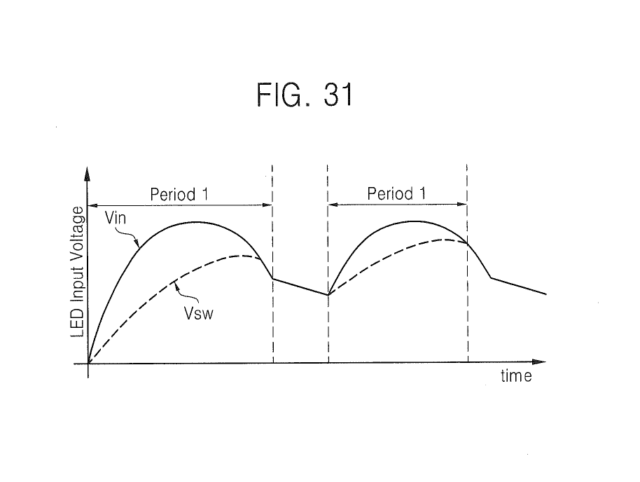

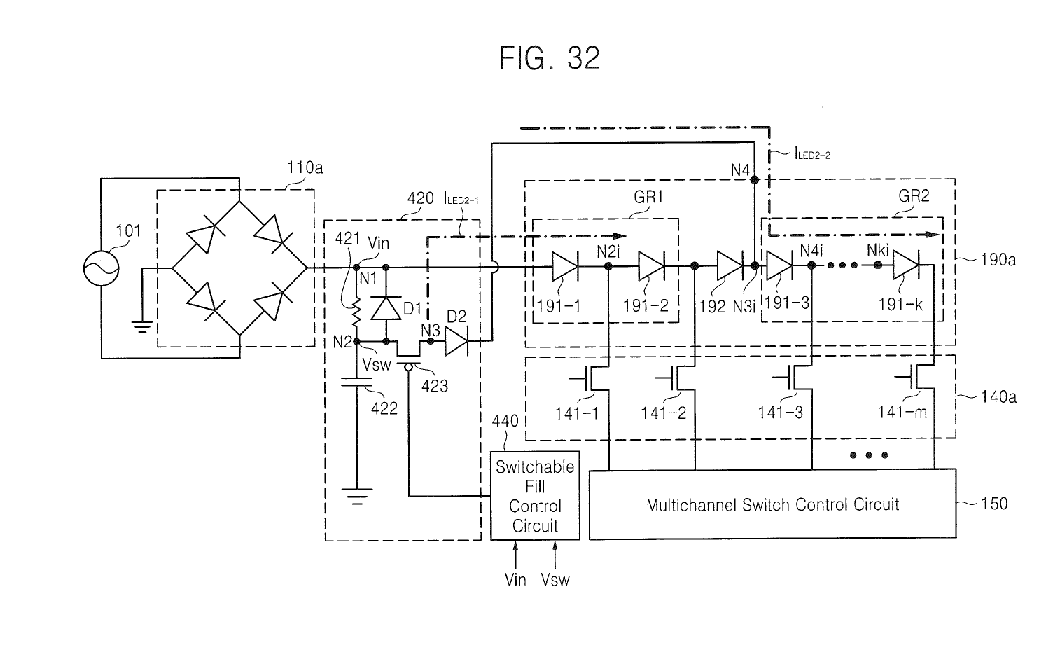

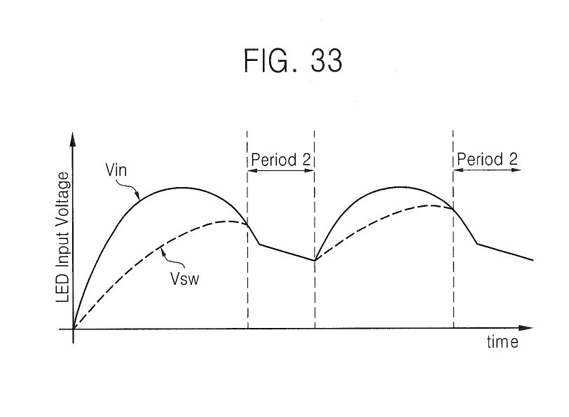

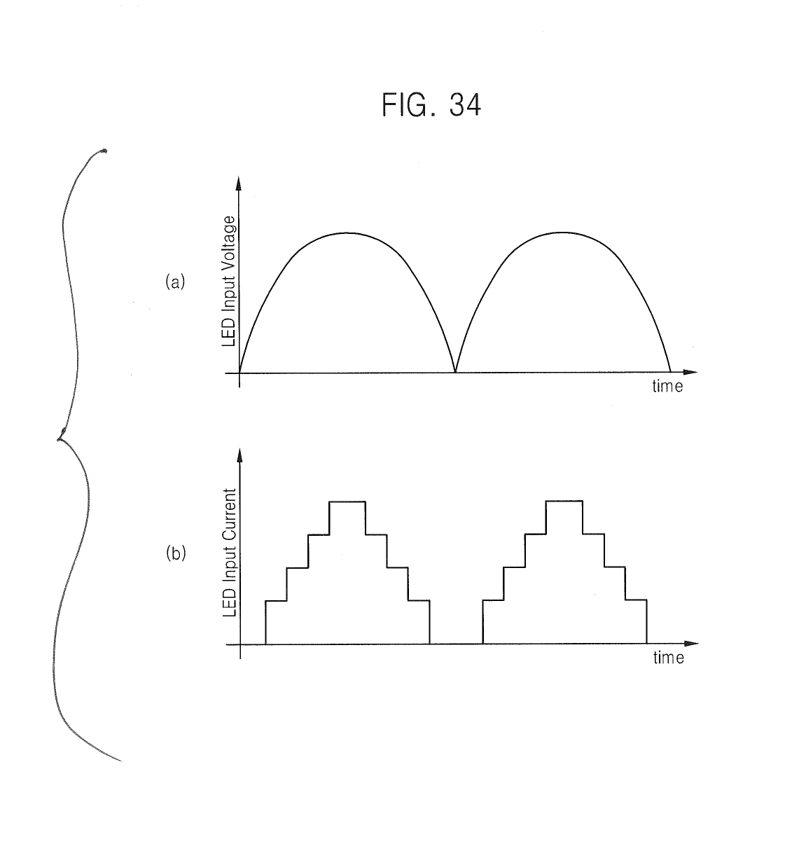

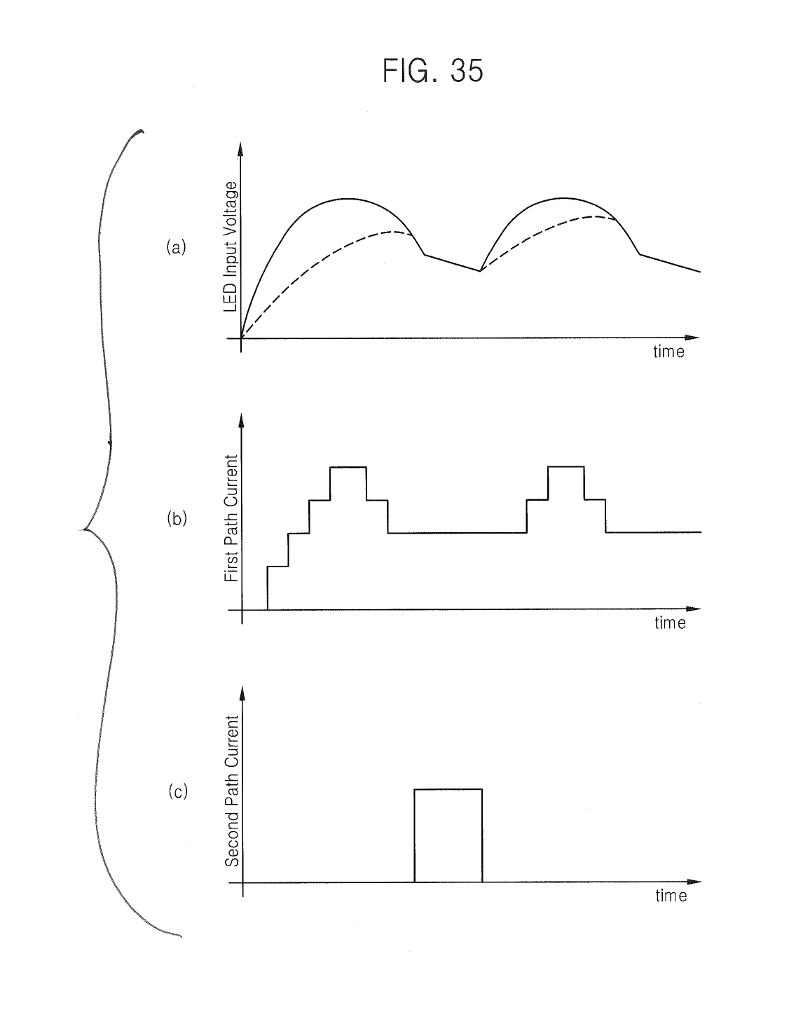

FIG. 35 is a schematic waveform diagram of LED input voltage and current in the LED driving circuit illustrated in FIGS. 30 and 32.

### MODE FOR CARRYING OUT THE INVENTION

Hereinafter, the present invention will be described in detail by explaining preferred embodiments of the invention with reference to the attached drawings.

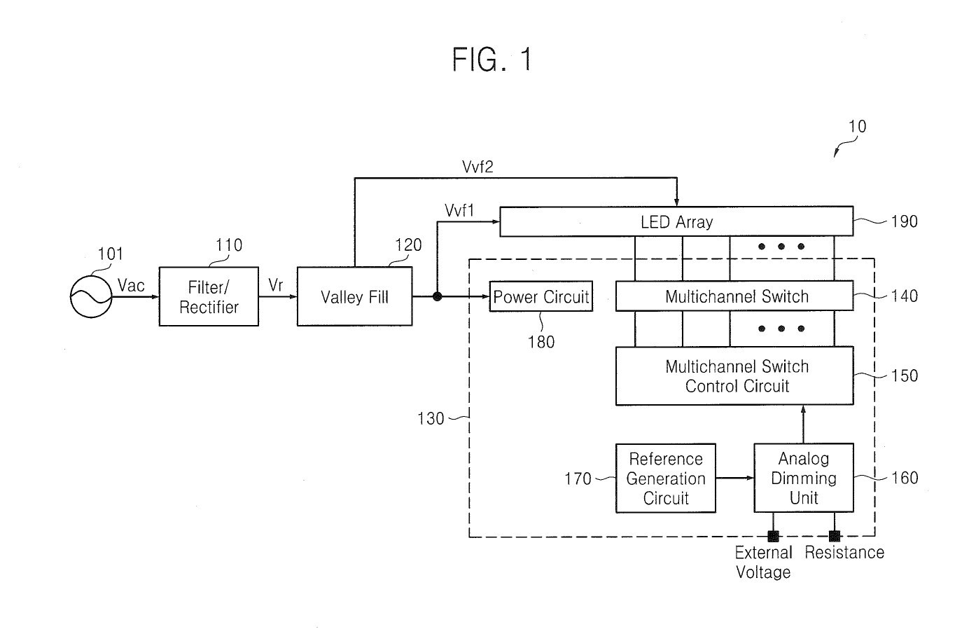

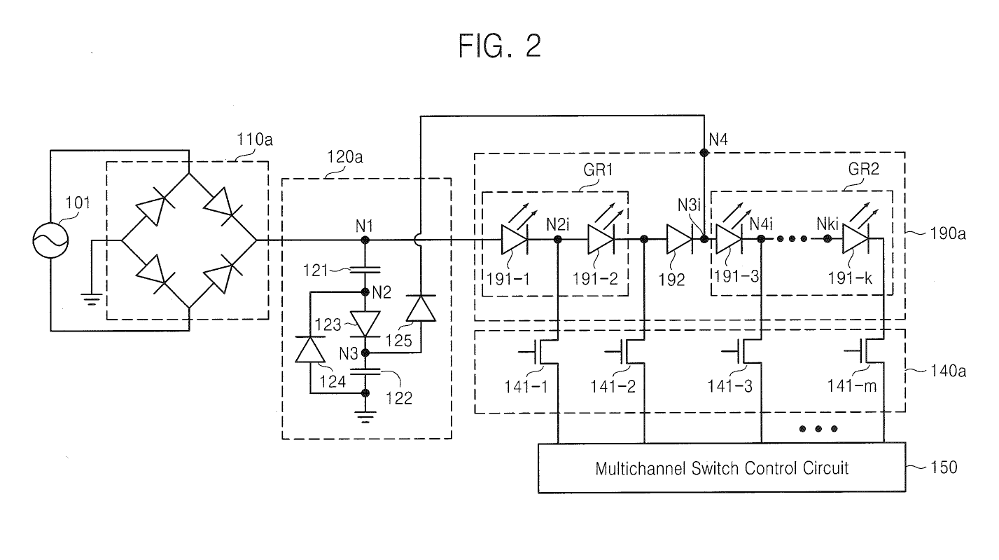

FIG. 1 is a schematic block diagram of a light emitting diode (LED) driving circuit according to the present invention. FIG. 2 is a circuit diagram of a filter/rectifier, a valley-fill circuit, and an LED array illustrated in FIG. 1 according to an embodiment of the present invention. Referring to FIGS. 1 and 2, an LED driving circuit 10 includes a filter/rectifier 110, a valley-fill circuit 120, and a control unit 130.

The filter/rectifier 110 receives an alternating current (AC) voltage Vac from an AC power 101 and performs noise-filtering and rectification of the AC voltage Vac to output a rectified voltage Vr. The AC voltage Vac may be a commercial AC voltage (e.g., 110 V or 220 V) but is not restricted thereto.

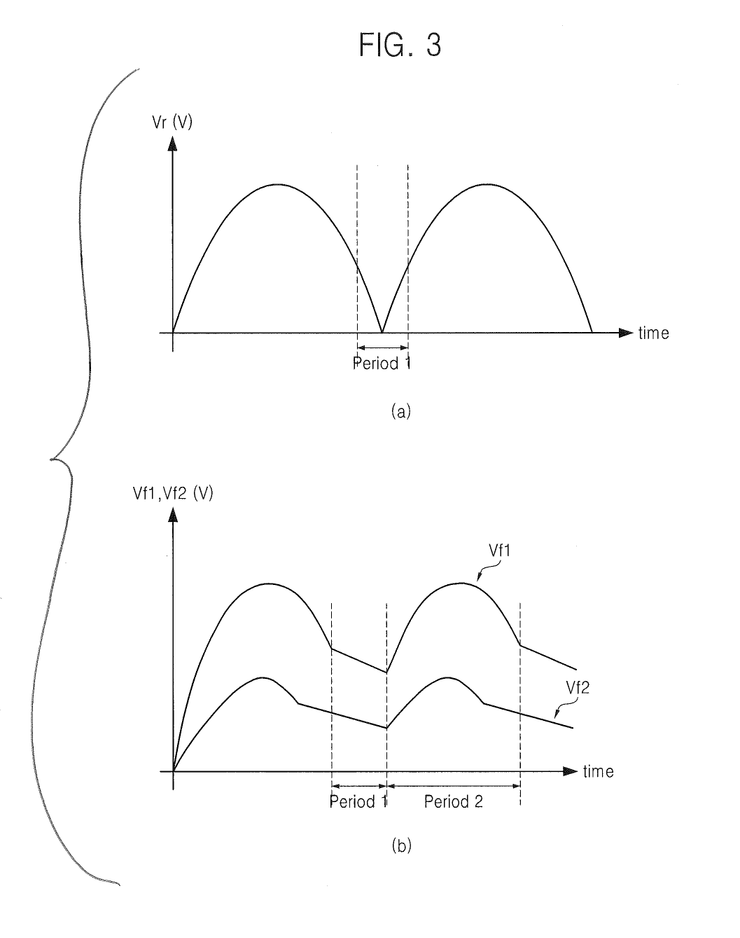

In FIG. 3, (a) is a schematic diagram of the waveform of the rectified voltage Vr according to an embodiment of the present invention. The valley-fill circuit 120 receives the rectified voltage Vr and outputs first and second transformed rectified voltages Vvf1 and Vvf2.

In FIG. 3, (b) is a schematic diagram of the waveforms of the first and second transformed rectified voltages Vvf1 and Vvf2 output from the valley-fill circuit 120. Referring to FIG. 3(b), the first transformed rectified voltage Vvf1 is a voltage of a first node N1 in FIG. 2 and does not decrease below a predetermined minimum voltage unlike the rectified voltage Vr. The second transformed rectified voltage Vvf2 is a voltage of a fourth node N4 in FIG. 2 and does not decrease the predetermined minimum voltage like the first transformed rectified voltage Vvf1. The valley-fill circuit 120 may transform a voltage in a valley period, in which the waveform of the rectified voltage Vr falls below a predetermined voltage, to be higher than the minimum voltage using at least one capacitor.

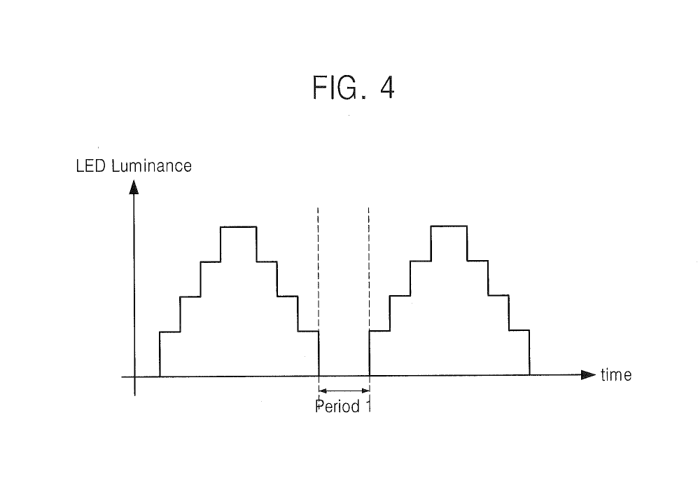

When it is assumed that the rectified voltage Vr shown in FIG. 3(a) is directly applied to the LED array 190, current does not flow into the LED array 190 during period 1 in which the rectified voltage Vr falls below the minimum voltage. Accordingly, the LED array 190 is not driven to emit light. Therefore, as shown in FIG. 4, the LED array 190 is entirely turned off in period 1, so that LED luminance is 0 in period 1. It results in severe flicker.

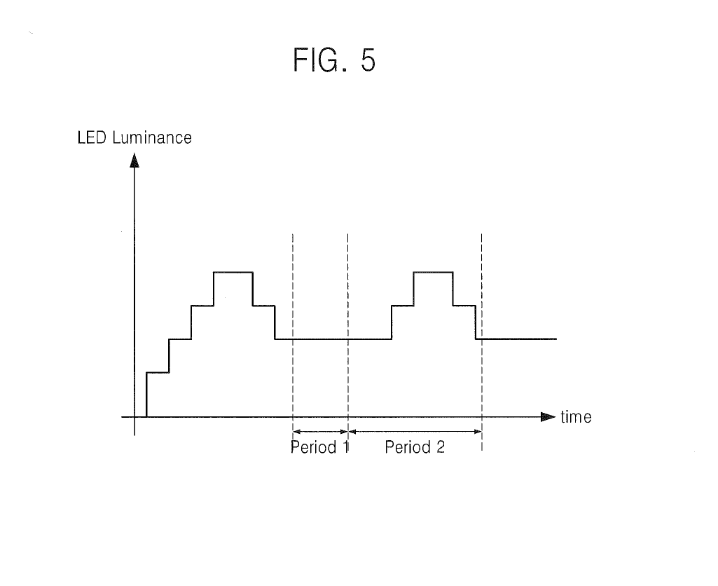

Contrarily, when the transformed rectified voltages Vvf1 and Vvf2, as shown in FIG. 3(b), generated by the valley-fill circuit 120 is applied to the LED array 190; charges in the at least one capacitor of the valley-fill circuit 120 are discharged to the LED array 190 in period 1 (referred to as the “valley period”), so that current flows into part of the LED array 190, letting the LED array 190 emit light. As a result, a period in which the LED array 190 is entirely turned off does not occur. Consequently, as shown in FIG. 5, the LED array 190 is partly turned on even in period 1 so that the LED luminance is maintained at least a predetermined value. Therefore, the flicker is reduced.

According to an embodiment of the present invention, an LED array 190a may include first through k-th LED groups 191-1 through 191-k connected in series, where “k” is an integer of at least 2. Each of the LED groups 191-1 through 191-k may include at least one LED. When one of the LED groups 191-1 through 191-k includes a plurality of LEDs, the LEDs in the LED group may be connected with one another in series, in parallel, or in a combination of series and parallel.

The control unit 130 includes a multichannel switch circuit 140 including “m” switches connected to the LED array 190 and a multichannel switch control circuit 150 for selectively opening or closing the switches, where “m” is an integer of at least 2.

In the embodiment illustrated in FIG. 2, a multichannel switch circuit 140a may include “m” switches 141-1 through 141-m corresponding one-on-one to the first through k-th LED groups 191-1 through 191-k. In other words, “m” may be the same as “k”. Each of the first through m-th switches 141-1 through 141-m is connected to an output node of a corresponding one of the LED groups 191-1 through 191-k among output nodes N2i through Nki and is selectively opened or closed by the multichannel switch control circuit 150, so that LED groups can be selectively driven.

In the embodiment illustrated in FIG. 2, the number of LED groups, “k”, is the same as the number of switches, “m”, but the present invention is not restricted to the current embodiment. Other various embodiments will be described later.

In the embodiment illustrated in FIG. 2, a filter/rectifier 110a may be implemented as a bridge diode.

In the embodiment illustrated in FIG. 2, the valley-fill circuit 120a includes first and second capacitors 121 and 122 and first through third diodes 123 through 125.

The first capacitor 121 may be connected between the first node N1 and a second node N2, the first diode 123 may be connected between the second node N2 and a third node N3, and the second capacitor 122 may be connected between the third node N3 and the ground. The second diode 124 may be connected between the ground and the second node N2, the third diode 125 may be connected between the third node N3 and the fourth node N4.

The first node N1 may be connected to an input of the first LED group 191-1 of the LED array 190a and the fourth node N4 may be connected to an input of one of the other LED groups 191-2 through 191-k.

For instance, the fourth node N4 is connected to an input of the j-th LED group 191-j among the first through k-th LED groups 191-1 through 191-k, where “j” is an integer of at least 2 and at most “k”. An anti-reverse diode 192 may be between the j-th LED group and the (j−1)-th LED group and the fourth node N4 may be connected between the anti-reverse diode 192 and the j-th LED group 191-j.

The anti-reverse diode 192 may be connected between an output of one LED group (e.g., the (j−1)-th LED group) and an input of a subsequent LED group (e.g., the j-th LED group 191-j. In an embodiment illustrated in FIG. 2, the anti-reverse diode 192 is connected between an output of the second LED group 191-2 and an input of the third LED group 191-3, but the present invention is not restricted to the current embodiment.

The first node N1 is connected to the input of the first LED group 191-1 of the LED array 190a and the fourth node N4 is connected to an input of the third LED group 191-3, i.e., an output of the anti-reverse diode 192.

Accordingly, an input to the first LED group 191-1 through the first node N1 may form a primary current path and an input to the third LED group 191-3 through the fourth node N4 may form a secondary current path.

For convenience' sake in the description, LEDs connected between the first node N1 and the fourth node N4 are classified into a GR1 LED group connected to the primary current path and subsequent LEDs connected to the fourth node N4 are classified into a GR2 LED group.

When it is assumed that the fourth node N4 is connected to the input of the j-th LED group 191-j, LEDs connected starting from the first LED group 191-1 up to the (j−1)-th LED group may be classified into the GR1 LED group and LEDs connected starting from the j-th LED group 191-j up to the k-th LED group 191-k may be classified into the GR2 LED group. The control unit may also include an analog dimming unit 160, a reference generation circuit 170, and a power circuit 180.

The analog dimming unit 160 controls current flowing in each switch through the multichannel switch circuit 140 connected to the LED array 190, thereby controlling LED brightness.

The analog dimming unit 160 may use a driving current predetermined for each channel or may control a driving current for each channel according to external resistance and an external analog signal.

The reference generation circuit 170 generates a reference voltage or current necessary for the operation of the analog dimming unit 160. The reference generation circuit 170 may be implemented as a bandgap circuit, but the present invention is not restricted to the current embodiment.

The power circuit 180 generates a voltage or current necessary for the internal operation of the control unit 130. For instance, the power circuit 180 may receive the first transformed rectified voltage Vvf1 which is one of the output voltages of the valley-fill circuit 120 and may generate a direct current (DC) voltage.

In the above-described embodiments, the LED driving circuit 10 is an AC voltage direct type LED driving circuit directly using an AC voltage to drive an LED instead of converting an AC voltage into a DC voltage to drive the LED.

According to the embodiments of the present invention, when the fourth node N4 is connected with the j-th LED group 191-j, as shown in FIG. 2; the first through 0-1)-th LED groups 191-1 through 191-j−1 may be classified into the GR1 LED group and the j-th through k-th LED groups 191-j through 191-k may be classified into the GR2 LED group. When an absolute value of the input voltage Vac from the AC power 101 is greater than the voltage Vvf1 charged at a capacitor of the valley-fill circuit 120a, as shown in period 2 shown in FIG. 3, current flows from the AC power 101 to a switch through the LED groups GR1 and GR2. The multichannel switch control circuit 150 controls regulated current to flow in the LED groups GR1 and GR2 and the switch. At this time, since there is a single LED current path, a control signal needs to be generated so that the current flows in a single switch.

When the second transformed rectified voltage Vvf2 is higher than an anode voltage of the anti-reverse diode 192, a current path from the fourth node N4 to the GR2 LED group is additionally generated. In other words, current flows in the GR1 LED group due to the voltage Vvf1 of the first node N1 and current flows in the GR2 LED group due to the voltage Vvf2 of the fourth node N4 in period 1 shown in FIG. 3(b). Accordingly, a control signal for generating a signal allowing current to flow in one of the switches connected with the GR1 LED group and in one of the switches connected with the GR2 LED group at the same time is necessary in period 1 shown in FIG. 3(b). When such method is used, the number of LEDs in which current flows and luminance double as compared to conventional technology. In addition, flicker is reduced.

As described above, according to the embodiments of the present invention, the first output of the valley-fill circuit 120, i.e., the first transformed rectified voltage Vvf1 is connected to the input to the first LED group 191-1 in the LED array 190 and the other output of the valley-fill circuit 120, i.e., the second transformed rectified voltage Vvf2 is connected to an input of another LED group in the LED array 190 to drive the LED array 190. Accordingly, power of the second capacitor 122 of the valley-fill circuit 120 forms a separate LED driving current path, so that higher luminance is provided with the same number of LEDs or a luminance difference-over-time caused when an LED array connected to multiple channels is sequentially driven is reduced. As a result, a flicker characteristic is improved.

In FIG. 2, the number of LEDs connected in series in the GR2 LED group connected to the secondary current path may be the same as the number of LEDs connected in series in the GR1 LED group connected to the primary current path. However, the GR1 LED group connected to the primary current path and the GR2 LED group connected to the secondary current path may be variously modified.

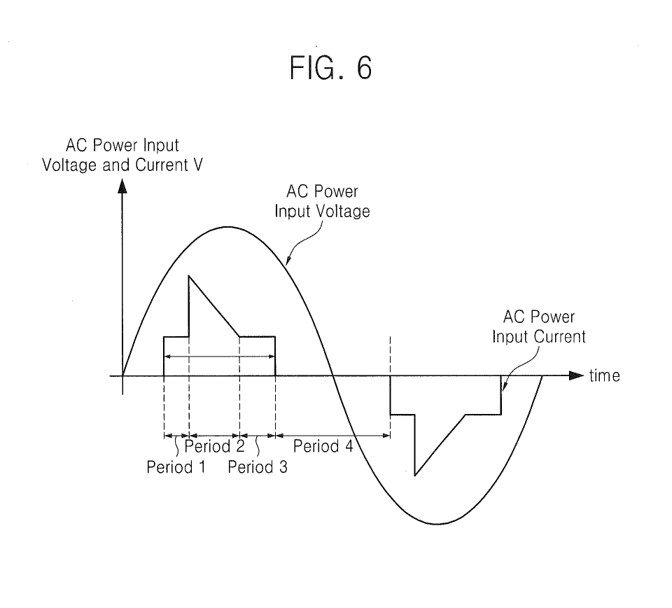

When the number of LEDs connected in series in the GR2 LED group connected to the secondary current path is equal to or greater than the number of LEDs connected in series in the GR1 LED group connected to the primary current path, the number of LEDs that emit light increases due to the secondary current path. Therefore, an LED input voltage decreases and time during which an AC input current flows increases in period 1, as shown in FIG. 6. As a result, total harmonic distortion (THD) is improved. FIG. 6 illustrates the waveforms of the voltage Vac and current of the AC power 101. In FIG. 6, period 1 shows a current flowing from the AC power 101 to the LED array 190 and period 2 shows a current flowing from the AC power 101 to the LED array 190 and a current charged to a capacitor of the valley-fill circuit 120. Period 3 shows a current flowing from the AC power 101 to the LED array 190. Current does not flow from the AC power 101 in period 4 because the voltage Vac of the AC power 101 is lower than the first transformed rectified voltage Vvf1 At this time, current flows from the capacitors 121 and 122 of the valley-fill circuit 120 to the LED array 190. Disagreement between the current waveform of the AC power 101 and the voltage waveform of the AC power 101 causes THD to increase. Methods of decreasing the THD includes a method of decreasing the maximum current of the AC power 101 and a method of reducing the time (i.e., period 4) during which the current of the AC power 101 does not flow. When a resistor is additionally placed between the first and second capacitors 121 and 122 in the valley-fill circuit 120 in the embodiment illustrated in FIG. 2, the maximum current of the AC power 101 can be decreased. When the number of LEDs connected in series in the GR2 LED group is greater than the number of LEDs connected in series in the GR1 LED group, the first transformed rectified voltage Vvf1 shown in FIG. 3(b) decreases, and therefore, a period in which current flows from the AC power 101 to the LED array 190 increases while a period in which AC current does not flow decreases. As a result, THD is decreased.

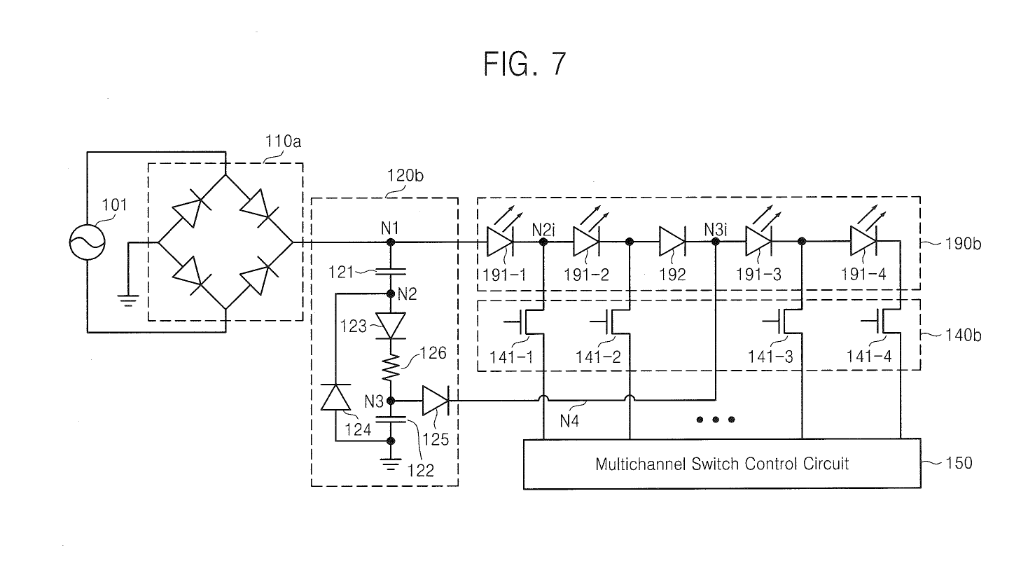

FIGS. 7 through 10 are circuit diagrams of the modifications of a valley-fill circuit, an LED array, and a multichannel switch circuit according to embodiments of the present invention.

The embodiment illustrated in FIG. 7 has a similar structure to the embodiment illustrated in FIG. 2. However, “k” and “m” are 4 in the embodiment illustrated in FIG. 7.

The anti-reverse diode 192 is connected between the output of the second LED group 191-2 and the input of the third LED group 191-3. The fourth node N4 is connected to the input of the third LED group 191-3, i.e., the output of the anti-reverse diode 192.

As compared to the valley-fill circuit 120a illustrated in FIG. 2, a valley-fill circuit 120b illustrated in FIG. 7 further includes a resistor 126 connected between the first diode 123 and the third node N3. As described above, when the resistor 126 is added between the first and second capacitors 121 and 122 in the valley-fill circuit 120b, the maximum current of the AC power 101 can be reduced.

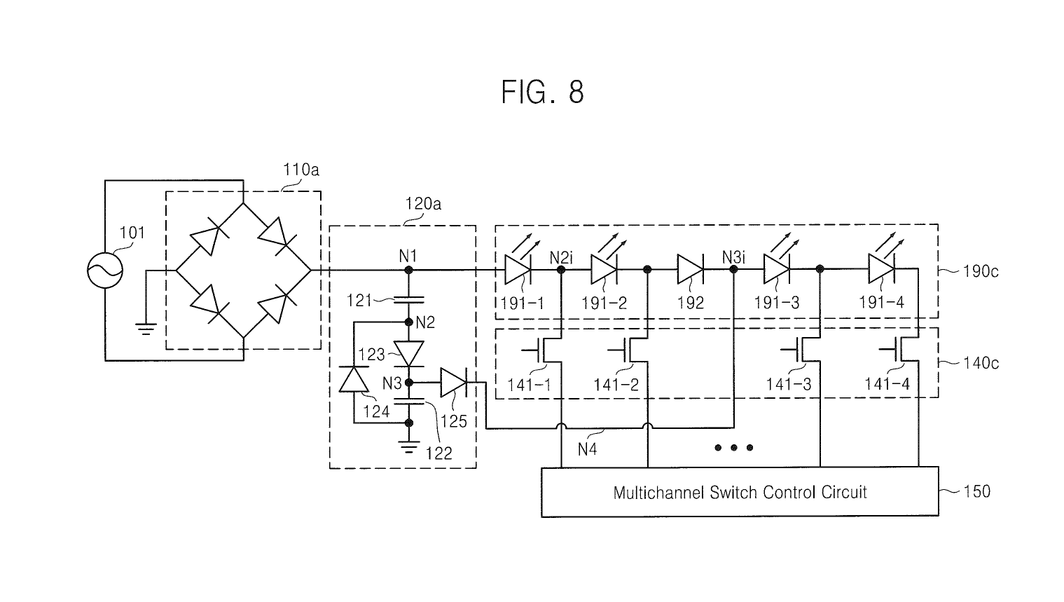

In the embodiment illustrated in FIG. 8, “k” and “m” are 4.

The anti-reverse diode 192 is connected between the output of the second LED group 191-2 and the input of the third LED group 191-3. The fourth node N4 is connected to the input of the third LED group 191-3.

The valley-fill circuit 120a illustrated in FIG. 8 is the same as the valley-fill circuit 120a illustrated in FIG. 2. An LED array 190c and a multichannel switch circuit 140c illustrated in FIG. 8 are the same as an LED array 190b and a multichannel switch circuit 140b illustrated in FIG. 7.

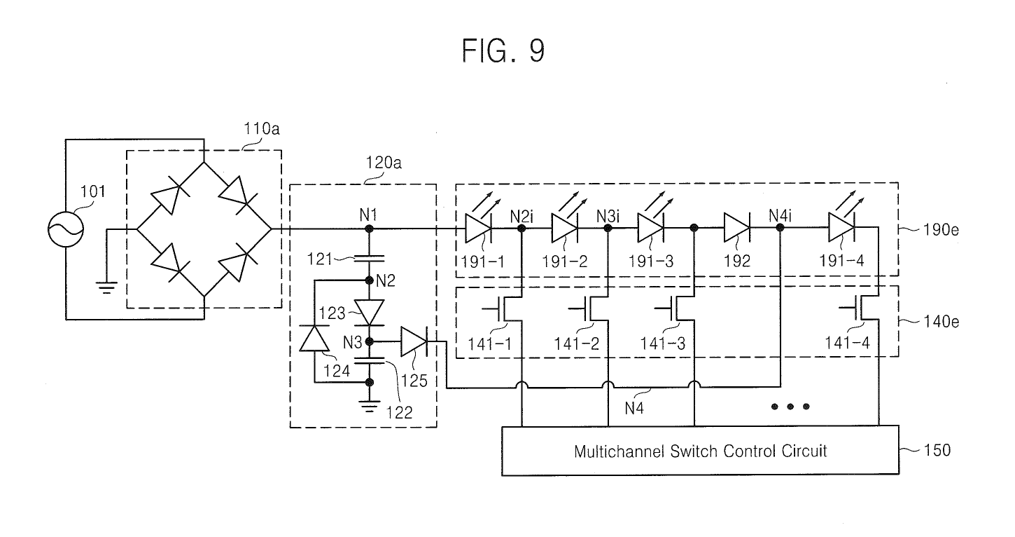

In the embodiment illustrated in FIG. 9. “k” and “m” are also 4.

The embodiment illustrated in FIG. 9 has a similar structure to the embodiment illustrated in FIG. 8. However, in the embodiment illustrated in FIG. 9 the anti-reverse diode 192 is connected between the output of the third LED group 191-3 and the input of the fourth LED group 191-4 and the fourth node N4 is connected to the input of the fourth LED group 191-4.

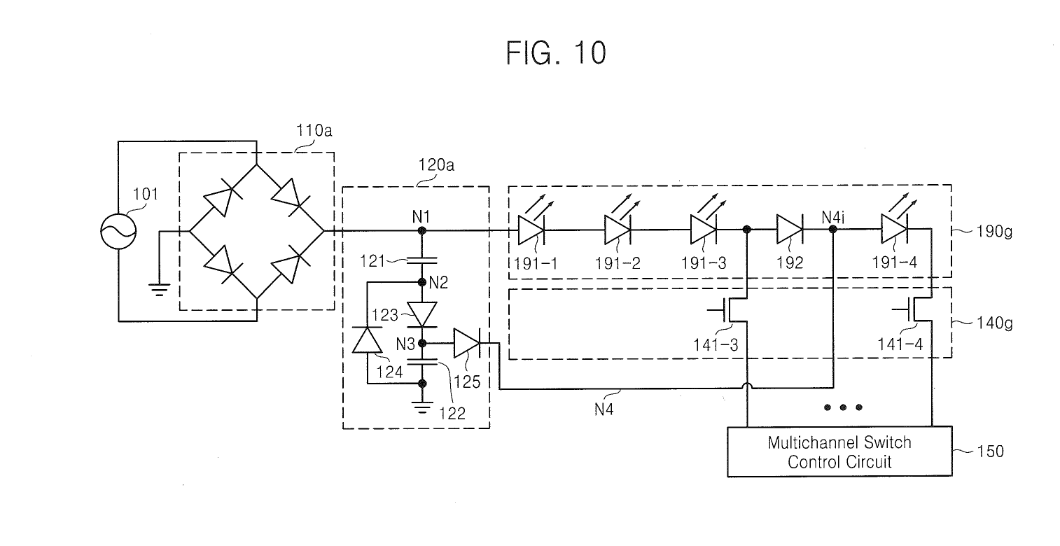

In the embodiment illustrated in FIG. 10, “k” is 4 and “m” is 2. One switch 141-3 is connected with the GR1 LED group including the first through third LED groups 191-1 through 191-3 and one switch 141-4 is connected with the GR2 LED group 191-4.

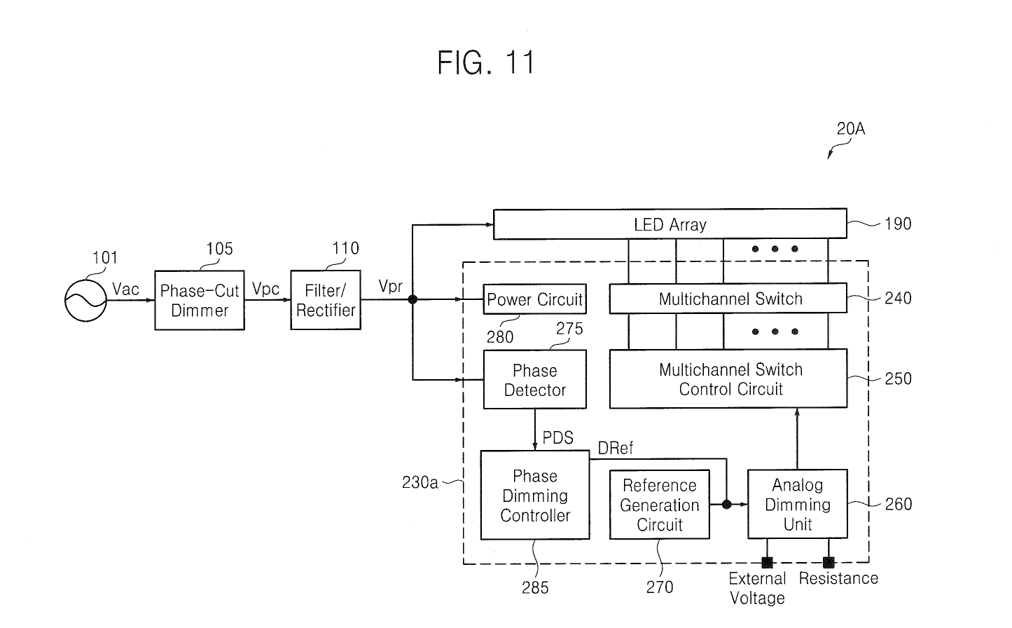

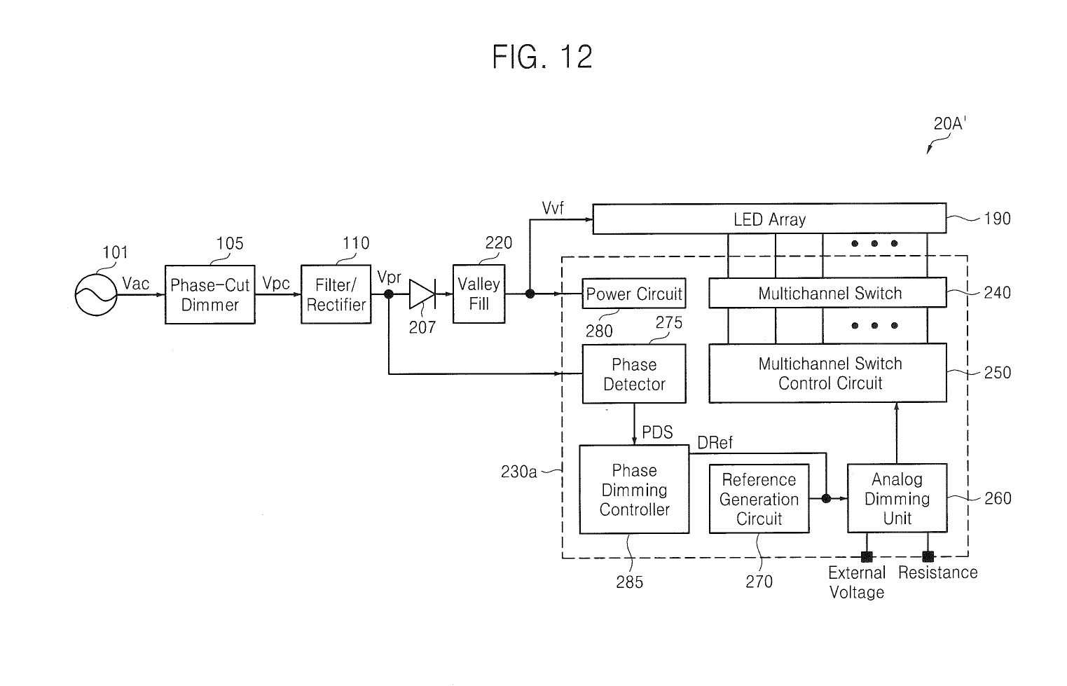

FIGS. 11 and 12 are schematic block diagrams of LED driving circuits according to other embodiments of the present invention. Referring to FIG. 11, an LED driving circuit 20A includes the filter/rectifier 110 and a control unit 230a. Referring to FIG. 12, an LED driving circuit 20A′ is different than the LED driving circuit 20A illustrated in FIG. 11 in that the LED driving circuit 20A′ further includes a valley-fill circuit 220. The LED driving circuit 20k may also include a diode 207 between the filter/rectifier 110 and the valley-fill circuit 220.

A phase-cut dimmer 105 may be inserted between the AC power 101 and the filter/rectifier 110. The phase-cut dimmer 105 is a device for controlling the brightness of LED lighting and has a function of removing (referred to as “phase-cutting”) part (e.g., 10%) of each cycle of the AC voltage Vac.

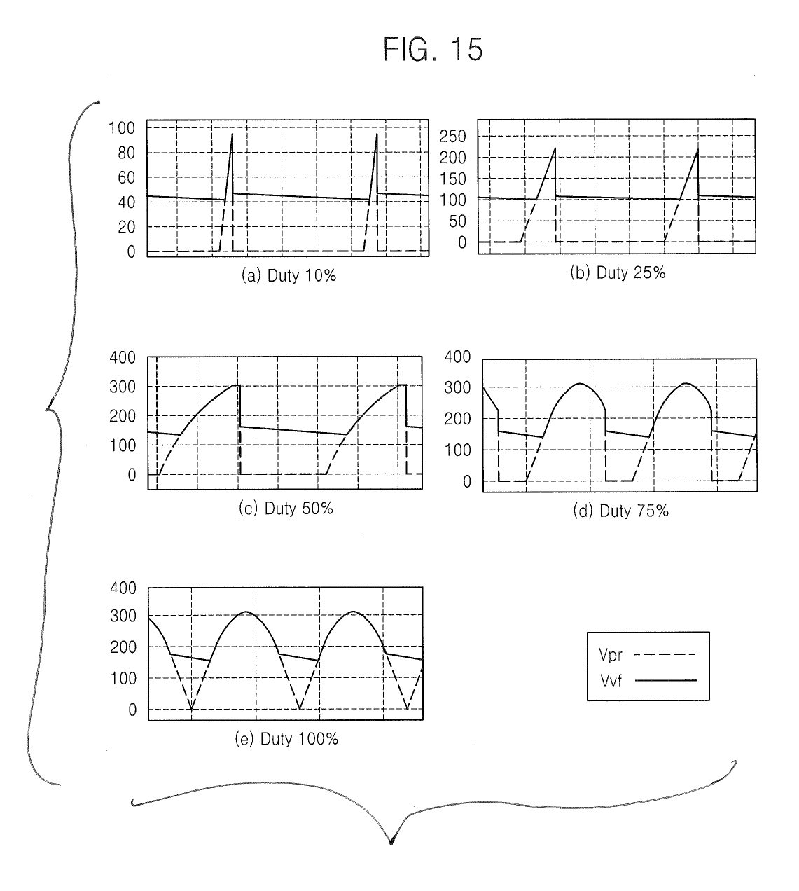

The filter/rectifier 110 receives a phase-cut AC voltage Vpc from the phase-cut dimmer 105 and performs noise filtering and rectification to output a rectified voltage Vpr. FIG. 15 illustrates voltage waveforms of the rectified voltage Vpr according to various embodiments of the present invention. Referring to FIG. 15, (a) through (d) respectively show the waveforms of the rectified voltage Vpr in 90, 75, 50 and 25% phase-cutting cases and the waveforms of an output voltage Vvf of the valley-fill circuit 220 in the respective phase-cutting cases and (e) shows the waveforms of the rectified voltage Vpr and the output voltage Vvf of the valley-fill circuit 220 when phase-cutting is not performed.

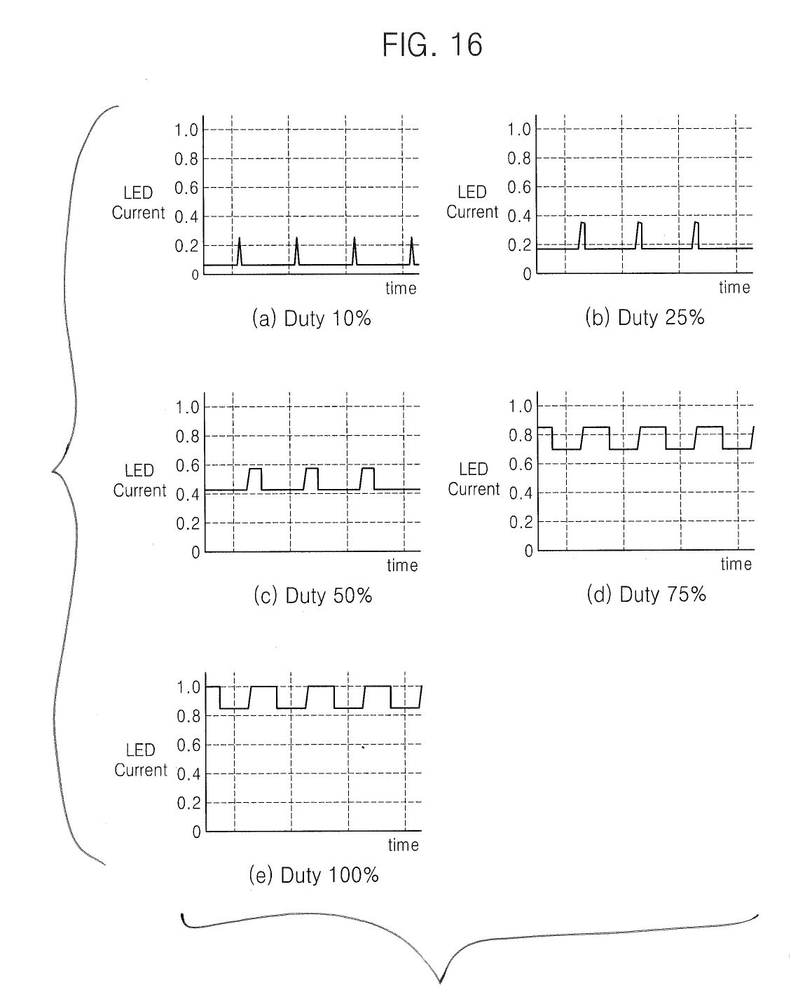

FIG. 16 illustrates current waveforms of an LED current according to various embodiments of the present invention. Referring to FIG. 16, (a) through (d) shows the waveforms of LED current in 90, 75, 50 and 25% phase-cutting cases, respectively, and (e) shows the waveform of the LED current when phase-cutting is not performed.

The valley-fill circuit 220 receives the rectified voltage Vpr and outputs the transformed rectified voltage Vvf to the LED array 190. Unlike the valley-fill circuit 120 that supplies different transformed rectified voltages to different nodes, respectively of the LED array 190 in the embodiment illustrated in FIG. 1; the valley-fill circuit 220 provides the transformed rectified voltage Vvf for only input of the LED array 190 and is not connected to other nodes in the LED array 190.

The valley-fill circuit 220 may be formed of a conventional valley-fill circuit. For instance, the valley-fill circuit 220 may be simply formed of a capacitor or may be implemented as an active valley-fill circuit including an active switch element and a capacitor.

Similarly to the control unit 130 illustrated in FIG. 1, the control unit 230a may include a multichannel switch circuit 240, a multichannel switch control circuit 250, an analog dimming unit 260, a reference generation circuit 270, and a power circuit 280. The structure and functions of the multichannel switch circuit 240, the multichannel switch control circuit 250, the analog dimming unit 260, the reference generation circuit 270, and the power circuit 280 are similar to those of the multichannel switch circuit 140, the multichannel switch control circuit 150, the analog dimming unit 160, the reference generation circuit 170, and the power circuit 180 illustrated in FIG. 1; thus the description thereof will be omitted.

The control unit 230a may also include a phase detector 275 and a phase dimming controller 285.

The phase detector 275 receives the phase-cut rectified voltage Vpr, detects a phase-cut rate, i.e., duty information, and generates a duty detection signal PDS. The phase dimming controller 285 controls driving current for each channel based on the duty detection signal PDS. Accordingly, luminance (i.e., LED brightness) is controlled according to the phase of the phase-cut dimmer 105.

When the phase dimming controller 285 controls the driving current for each channel based on the duty detection signal PDS, the driving current for each channel may be controlled according to an algorithm for controlling a dimming profile. The dimming profile shows the relationship between the degree of phase-cut and LED brightness.

FIGS. 26 and 27 are graphs showing the dimming profile according to embodiments of the present invention. FIG. 26 shows the dimming profile defined by National Electrical Manufacturers Association (NEMA) and FIG. 27 shows the dimming profile defined by Lighting Research Center (LRC).

According to the embodiments of the present invention, the dimming profile may be predetermined or may be controlled to have a certain slope or value using an algorithm. The dimming profile may also be controlled to be compliant with the standard defined by NEMA or LRC. The phase dimming controller 285 may control the brightness of an LED array by controlling a dimming reference voltage according to the predetermined dimming profile or the dimming profile controlled by the algorithm.

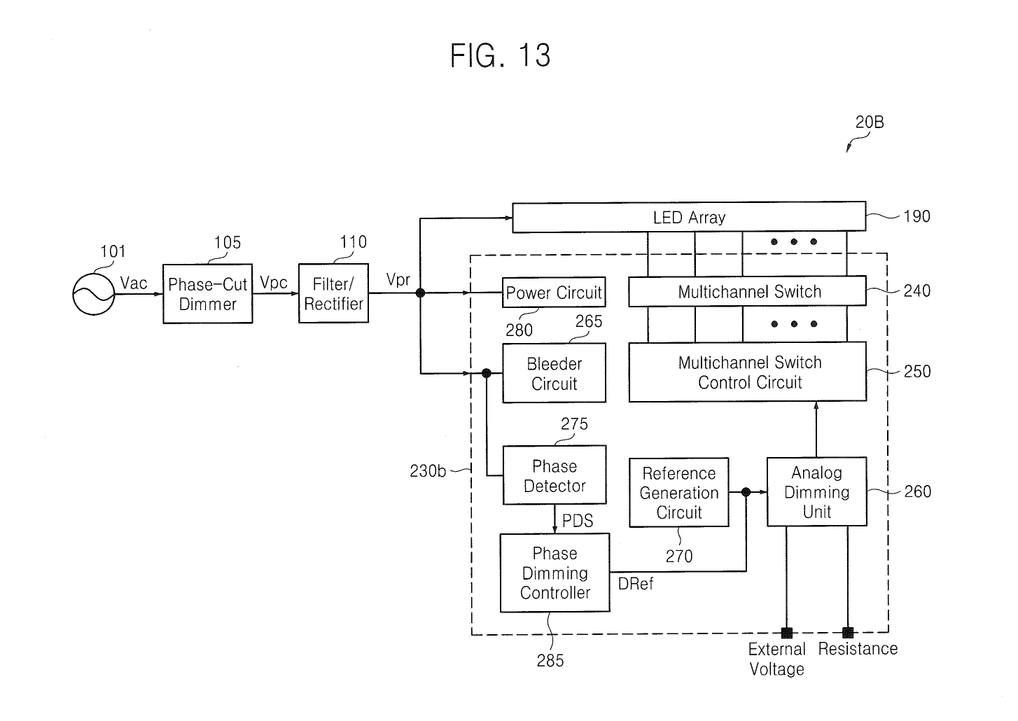

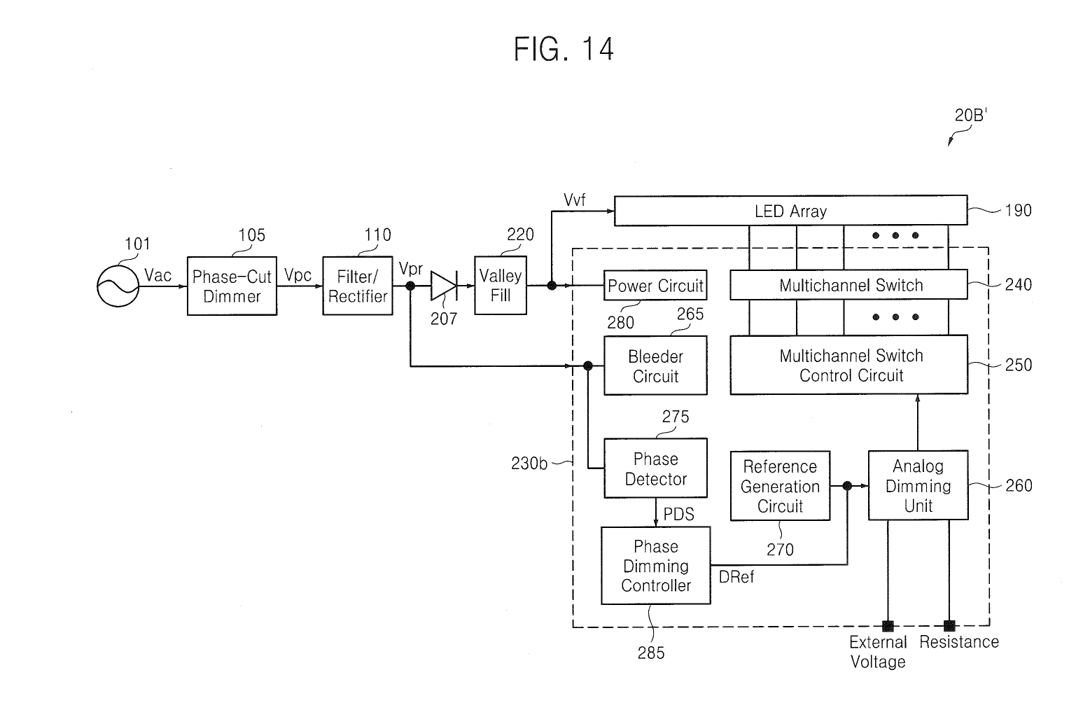

FIGS. 13 and 14 are block diagrams of the modifications of the LED driving circuits respectively illustrated in FIGS. 11 and 12. Referring to FIG. 13, similarly to the LED driving circuit 20A illustrated in FIG. 11, an LED driving circuit 20B includes the filter/rectifier 110 and a control unit 230b. Referring to FIG. 14, similarly to the LED driving circuit 20A′ illustrated in FIG. 12, an LED driving circuit 20B′ includes the filter/rectifier 110, the diode 207, the valley-fill circuit 220, and the control unit 230b.

However, the control unit 230b illustrated in FIGS. 13 and 14 may further include a bleeder circuit 265 as compared to the control unit 230a illustrated in FIGS. 11 and 12. The bleeder circuit 265 operates to guarantee holding current for the normal operation of a TRIAC dimmer which is a kind of the phase-cut dimmer 105. Although not shown, the bleeder circuit 265 may be implemented as a passive-type bleeder circuit including a resistor and a capacitor or an active bleeder circuit using an active element.

According to some embodiment of the present invention, even when the phase-cut AC power Vpc is supplied by the phase-cut dimmer 105, the valley-fill circuit 220 supplies a basic voltage and controls an LED driving current according to a phase resulting from phase-cutting, so that a phase-cut dimming operation with less flicker can be performed.

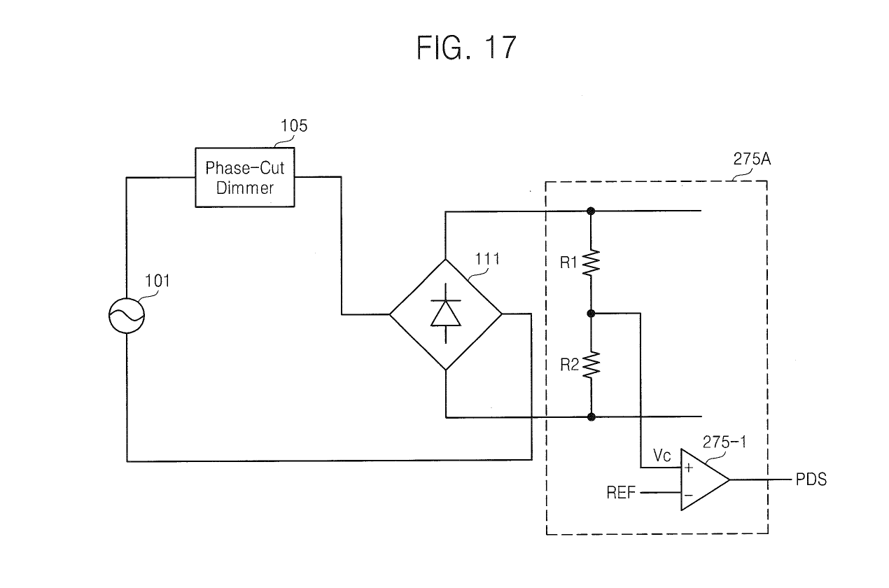

FIG. 17 is a circuit diagram of a phase detector 275A according to an embodiment of the present invention. Referring to FIG. 17, the phase detector 275A includes a comparator 275-1.

The comparator 275-1 compares a comparison target voltage Vc with a comparison reference voltage REF to detect the duty detection signal PDS. The comparison target voltage Vc is related with the phase-cut rectified voltage Vpr and may be, for example, a voltage obtained by dividing the phase-cut rectified voltage Vpr. In the embodiment illustrated in FIG. 17, the phase-cut rectified voltage Vpr is divided using resistors R1 and R2 and the division result is used as the comparison target voltage Vc.

While the comparison target voltage Vc is at least the comparison reference voltage REF, the duty detection signal PDS may be at a first logic level (e.g., “1”). While the comparison target voltage Vc is lower than the comparison reference voltage REF, the duty detection signal PDS may be at a second logic level (e.g., “0”). Accordingly, the duty detection signal PDS is a pulse signal having substantially the same cycle (or period) as the phase-cut rectified voltage Vpr and the duty ratio of the pulse is determined based on a phase-cut rate. The comparison target voltage Vc and the comparison reference voltage REF may be analog voltages.

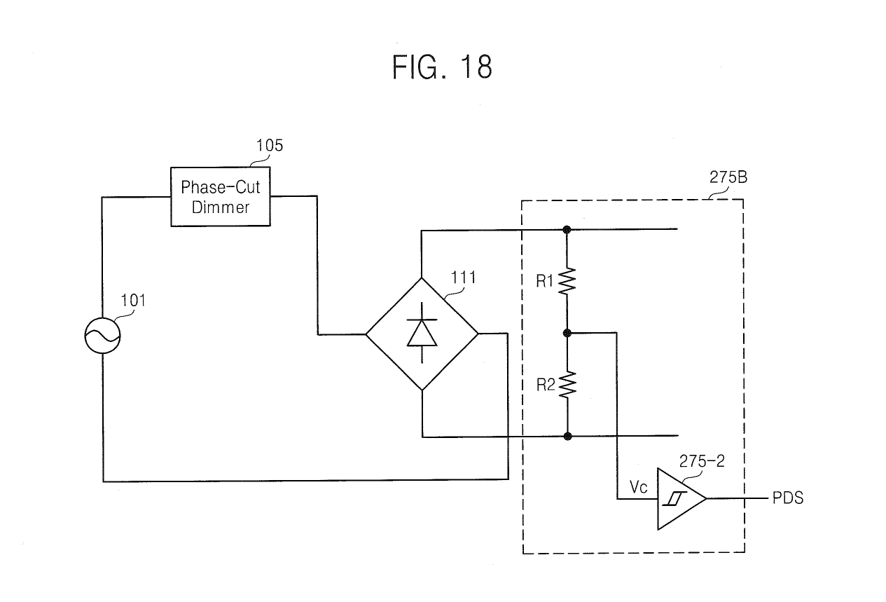

FIG. 18 is a circuit diagram of a phase detector 275B according to another embodiment of the present invention. Referring to FIG. 18, the phase detector 275B includes a Schmidt trigger 275-2.

The Schmidt trigger 275-2 is a comparator having hysteresis characteristics. The Schmidt trigger 275-2 has a trigger voltage predetermined in advance without a separate reference signal; and receives the comparison target voltage Vc and generates a pulse signal, i.e., the duty detection signal PDS.

In the embodiment illustrated in FIG. 18, the phase-cut rectified voltage Vpr is also divided using the resistors R1 and R2 and the division result is used as the comparison target voltage Vc.

Although not shown, at least one inverter instead of the Schmidt trigger 275-2 may be used. The logic threshold voltage of the inverter is set to be at least the comparison target voltage Vc.

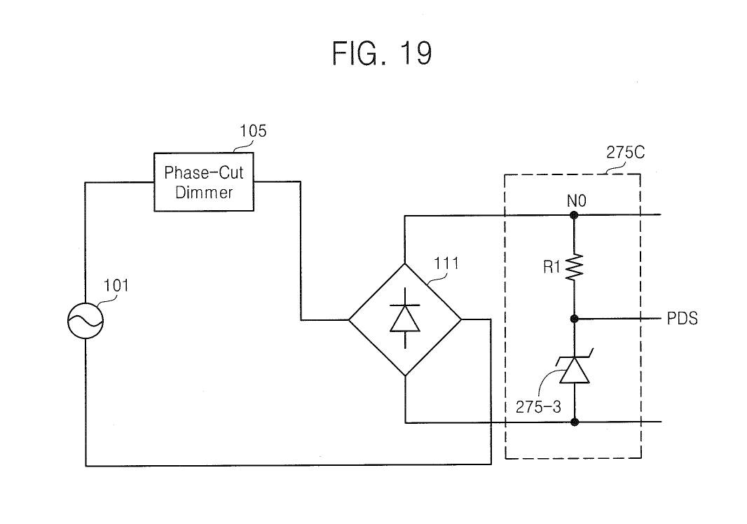

FIG. 19 is a circuit diagram of a phase detector 275C according to a further embodiment of the present invention. Referring to FIG. 19, the phase detector 275C includes a Zener diode 275-3. In detail, the phase detector 275C includes the resistor R1 and the Zener diode 275-3 which are connected in series between a node NO and the ground. When the Zener diode 275-3 is implemented as a 5-V Zener diode, around 5 V is output as the duty detection signal PDS in a period in which the phase-cut rectified voltage Vpr is at least 5 V; around 0 V is output in a period in which the phase-cut rectified voltage Vpr is lower than 5 V; and this output voltage may be used as the duty detection signal PDS or may be sent to a Schmidt trigger or at least one inverter. Although not shown, a Schmidt trigger, an inverter, a buffer, or a level shifter connected to the Zener diode 275-3 may also be provided.

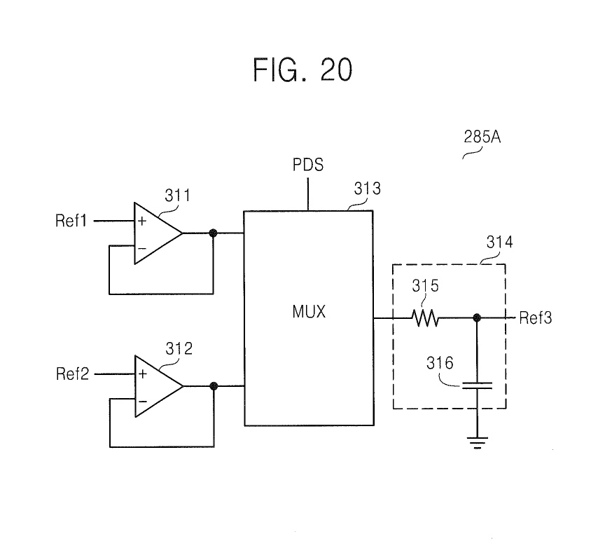

FIG. 20 is a circuit diagram of a phase dimming controller 285A according to an embodiment of the present invention. Referring to FIG. 20, the phase dimming controller 285A includes a multiplexer 313 and a low-pass filter 314. The multiplexer 313 multiplexes a first reference voltage Ref1 and a second reference voltage Ref2 in response to the duty detection signal PDS.

The first reference voltage Ref1 and the second reference voltage Ref2 may be analog voltages and the first reference voltage Ref1 may be higher than the second reference voltage Ref2, but the present invention is not restricted to the current embodiment. For instance, the first reference voltage Ref1 may be 5 V and the second reference voltage Ref2 may be 0 V.

The low-pass filter 314 includes a resistor 315 and a capacitor 316 and generates a third reference voltage Ref3 based on the output of the multiplexer 313. The third reference voltage Ref3 has a value between the first reference voltage Ref1 and the second reference voltage Ref2 and varies with the duty detection signal PDS.

The phase dimming controller 285A may also include buffers 311 and 312 in front of the multiplexer 313 to buffer the first reference voltage Ref1 and the second reference voltage Ref2, respectively. The buffers 311 and 312 each may be implemented as a source follower.

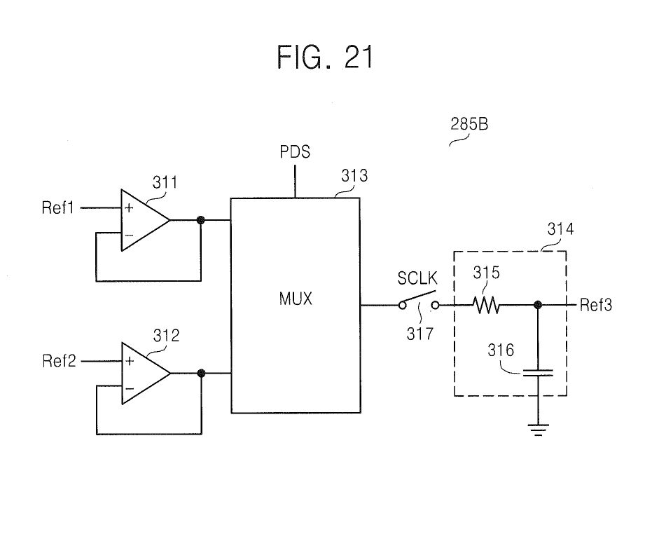

FIG. 21 is a circuit diagram of a phase dimming controller 285B according to another embodiment of the present invention. Referring to FIG. 21, the phase dimming controller 285B further includes a sampling switch 317 as compare to the phase dimming controller 285A.

The sampling switch 317 is connected between the multiplexer 313 and the low-pass filter 314 and is opened and closed in response to a sampling clock signal SCLK.

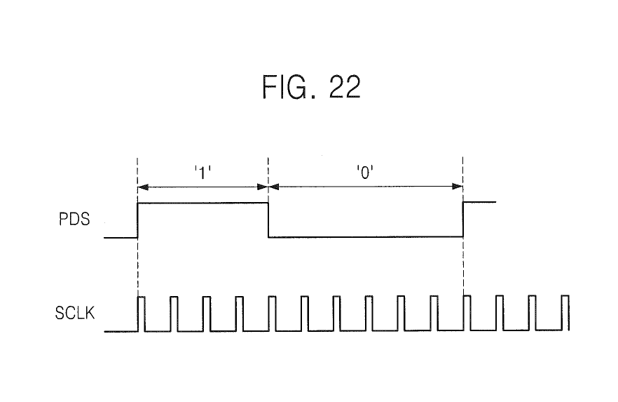

FIG. 22 illustrates the waveforms of the duty detection signal PDS and the sampling clock signal SCLK according to an embodiment of the present invention.

Referring to FIG. 22, the number of cycles in the sampling clock signal SCLK may be several times or several tens of times of the number of cycles in the duty detection signal PDS and a period of a first logic level (“1”) may be shorter than a period of a second logic level (“0”) in the sampling clock signal SCLK.

In the embodiment illustrated in FIG. 21, the first and second reference voltages Ref1 and Ref2 are sampled using the fast sampling clock signal SCLK and then transmitted to the capacitor 316. Accordingly, the size of the resistor 315 and the capacitor 316 can be reduced as compared to the embodiment illustrated in FIG. 20.

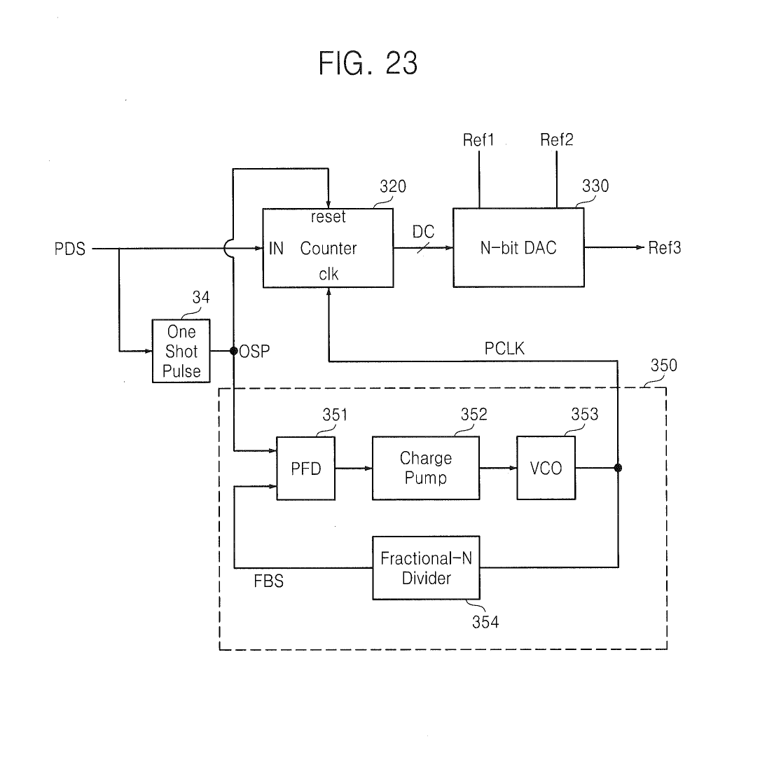

FIG. 23 is a circuit diagram of a phase dimming controller 285C according to a further embodiment of the present invention. Referring to FIG. 23, the phase dimming controller 285C includes a counter 320, a digital-to-analog converter (DAC) 330, a pulse generator 340, and a phase-locked loop (PLL) 350.

The duty detection signal PDS output from the phase detector 275 is applied to an input IN of the counter 320. The pulse generator 340 receives the duty detection signal PDS and generates a one-shot pulse signal OSP. For instance, the pulse generator 340 detects a rising edge or falling edge of the duty detection signal PDS and generates the pulse signal OSP, thereby outputting the one-shot pulse signal OSP in which a single pulse occurs per period of the duty detection signal PDS. The period of the one-shot pulse signal OSP is a period when the duty of the phase-cut rectified voltage Vpr is 100% (i.e., (e) in FIG. 15).

The one-shot pulse signal OSP is input to the PLL 350 and is also input to the counter 320 as a reset signal.

The PLL 350 includes a phase frequency detector (PFD) 351, a charge pump 352, a voltage-controlled oscillator (VCO) 353, and a divider 354.

The PFD 351 detects the difference in phase and frequency between the one-shot pulse signal OSP and a feedback signal FBS and outputs the detection result to the charge pump 352. The charge pump 352 pumps charges in response to an output signal of the PFD 351 to generate a voltage signal varying with the output signal of the PFD 351. The VCO 353 generates an oscillation signal PCLK according to the output voltage of the charge pump 352.

The divider 354 performs N-bit (where N is an integer of at least 2) division on the oscillation signal PCLK to generate the feedback signal FBS. For instance, the divider 354 may divide the frequency of the oscillation signal PCLK by 2^{N}.

According to the operation of the PLL 340, the feedback signal FBS and the one-shot pulse signal OSP are gradually synchronized with each other in terms of phase and frequency. In other words, a rising edge of the feedback signal FBS is synchronized with a rising edge of the one-shot pulse signal OSP by the PFD 351.

When the feedback signal FBS and the one-shot pulse signal OSP are synchronized, the oscillation signal PCLK may toggle 2^{N} times during a single period of the duty detection signal PDS.

The counter 320 may be an N-bit counter.

Accordingly, the oscillation signal PCLK generated to fit the N-bit counter 20 is applied to a clock clk of the counter 320.

The counter 320 counts rising or falling edges of the oscillation signal PCLK during a first logic level period (e.g., a high level period) of the duty detection signal PDS and outputs the count result as an N-bit digital code DC.

The N-bit digital code DC is applied to the N-bit DAC 330. The N-bit DAC 330 selects one of voltages obtained by dividing voltages between the first reference voltage Ref1 and the second reference voltage Ref2 by 2^{N} according to the N-bit digital code DC and outputs the selected voltage as the third reference voltage Ref3.

Accordingly, the third reference voltage Ref3, i.e., a voltage corresponding to the detected duty ratio among voltages between the first reference voltage Ref1 and the second reference voltage Ref2 is output due to the duty detection signal PDS generated by the phase detector 275.

The third reference voltage Ref3 is input to the analog dimming unit 260 as a dimming reference voltage DRef. The analog dimming unit 260 controls LED brightness by controlling current flowing in each switch through the multichannel switch circuit 240 connected to the LED array 190 based on the dimming reference voltage DRef.

The reference generation circuit 270 generates a reference voltage or current necessary for the operation of the analog dimming unit 260. The reference generation circuit 270 may be implemented as a bandgap circuit, but the present invention is not restricted to the current embodiment.

The power circuit 280 generates a voltage or current necessary for the internal operation of the control unit 230.

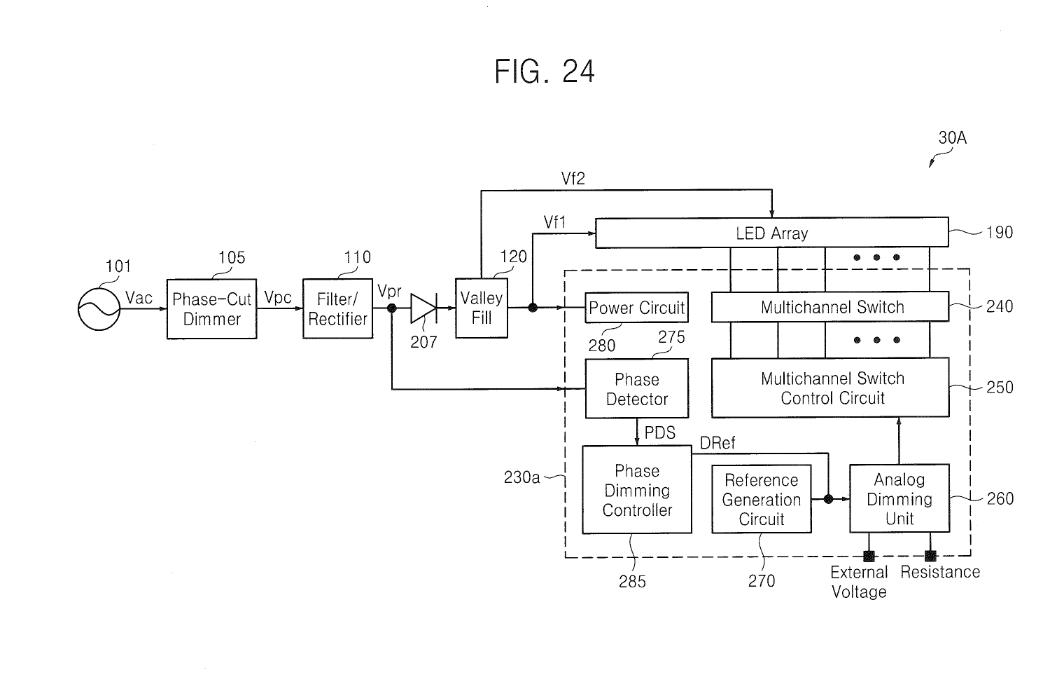

FIG. 24 is a schematic block diagram of an LED driving circuit 30A according to still another embodiment of the present invention. Referring to FIG. 24, the LED driving circuit 30A includes the filter/rectifier 110, the diode 207, the valley-fill circuit 120, and the control unit 230a.

The structure and operations of the LED driving circuit 30A illustrated in FIG. 24 are similar to those of the LED driving circuit 20A illustrated in FIG. 11. However, the LED driving circuit 30A illustrated in FIG. 24 includes the valley-fill circuit 120 illustrated in FIG. 1 instead of the valley-fill circuit 220 illustrated in FIG. 11.

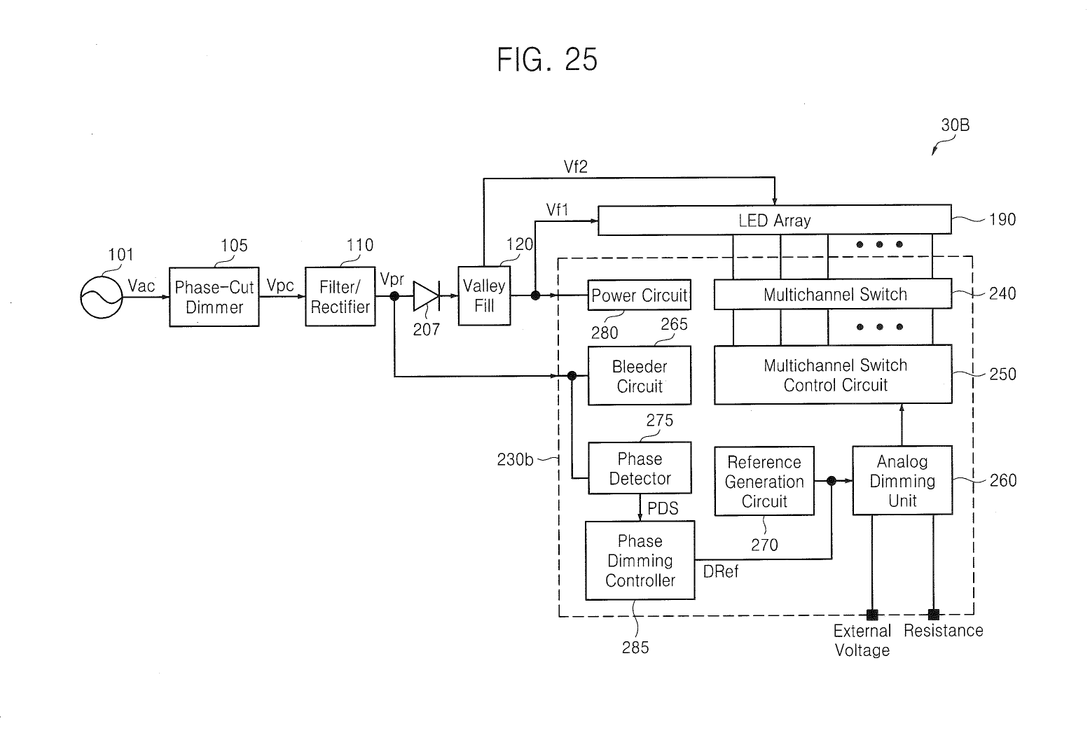

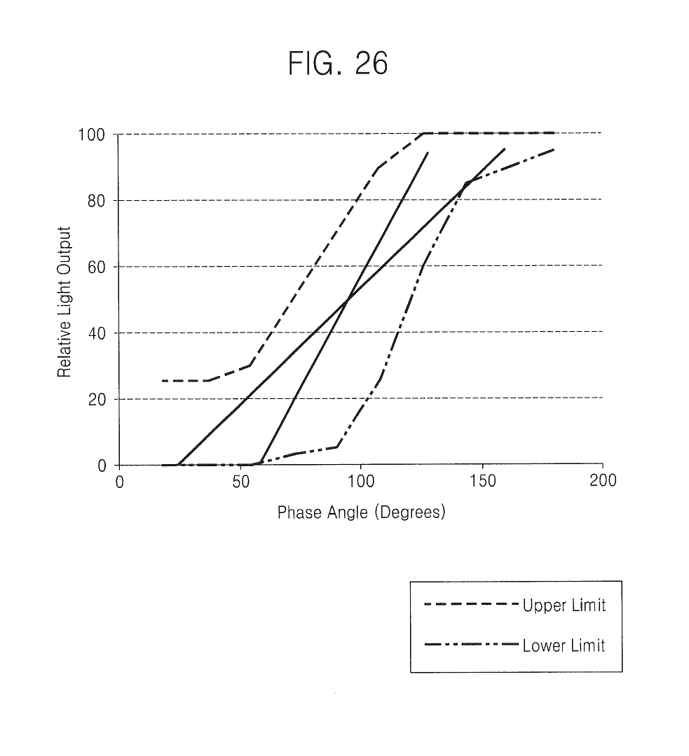

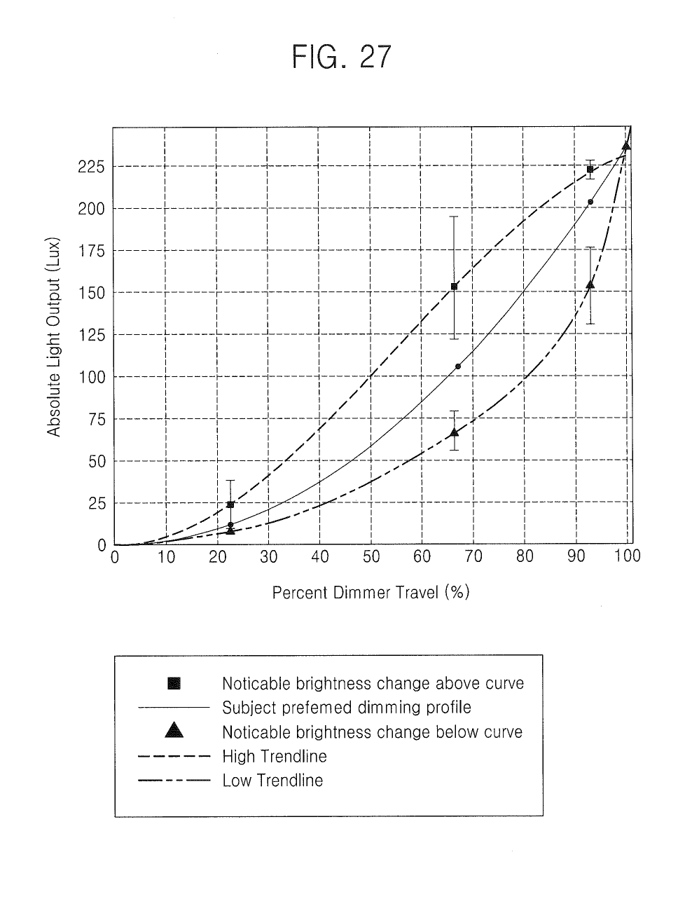

FIG. 25 is a block diagram of the modification of the LED driving circuit 30A illustrated in FIG. 24. Referring to FIG. 25, similarly to the LED driving circuit 30A illustrated in FIG. 24, an LED driving circuit 30B includes the filter/rectifier 110, the diode 207, the valley-fill circuit 220, and the control unit 230b.

However, the control unit 230b illustrated in FIG. 25 may further include the bleeder circuit 265 as compared to the control unit 230a illustrated in FIG. 24. The bleeder circuit 265 operates to guarantee holding current for the normal operation of a TRIAC dimmer which is a kind of the phase-cut dimmer 105. Although not shown, the bleeder circuit 265 may be implemented as a passive-type bleeder circuit including a resistor and a capacitor or an active bleeder circuit using an active element.

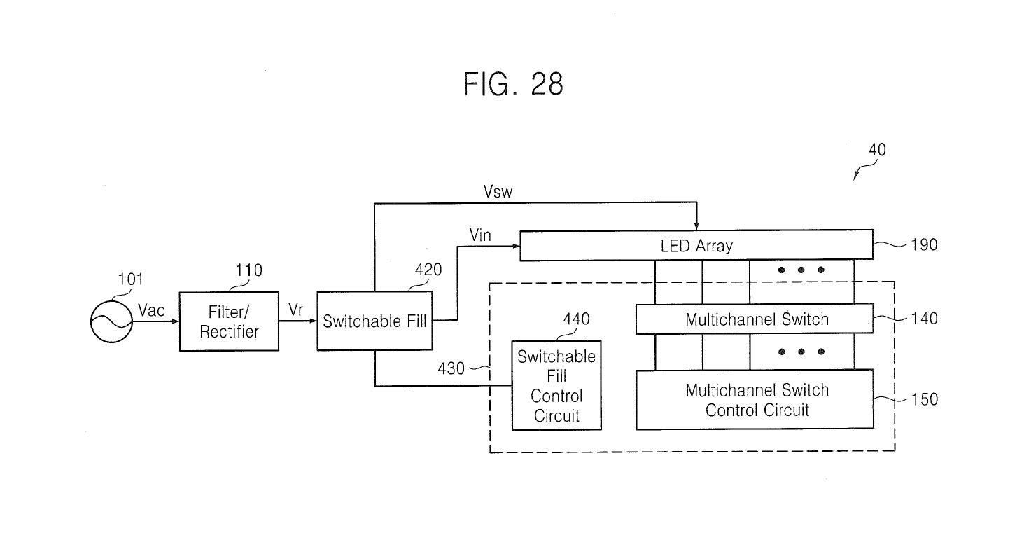

FIG. 28 is a schematic block diagram of an LED driving circuit according to a further embodiment of the present invention. FIG. 29 is a circuit diagram of the filter/rectifier 110, a switchable fill circuit 420, the multichannel switch circuit 140, and the LED array 190 illustrated in FIG. 28 according to an embodiment of the present invention. Referring to FIGS. 28 and 29, an LED driving circuit 40 includes the filter/rectifier 110, the switchable fill circuit 420, and a control unit 430.

The filter/rectifier 110 receives the AC voltage Vac from the AC power 101 and performs noise-filtering and rectification of the AC voltage Vac to output the rectified voltage Vr. The AC voltage Vac may be a commercial AC voltage (e.g., 110 V or 220 V) but is not restricted thereto.

The switchable fill circuit 420 receives the rectified voltage Vr and supplies current to the LED array 190.

The control unit 430 includes the multichannel switch circuit 140 including “m” switches connected to the LED array 190 and the multichannel switch control circuit 150 for selectively opening or closing the switches, where “m” is an integer of at least 2.

The control unit 430 may also include a switchable fill control circuit 440 to control the switchable fill circuit 420.

Although not shown, the control unit 430 may also include at least one among the analog dimming unit 160 or 260, the reference generation circuit 170 or 270, the power circuit 180 or 280, the bleeder circuit 265, the phase detector 275, and the phase dimming controller 285 illustrated in FIG. 1, 11, 12, 13, 14, 24, or 25.

In the embodiment illustrated in FIG. 29, the filter/rectifier 110a, the LED array 190a, the multichannel switch circuit 140a, and the multichannel switch control circuit 150 are the same as the filter/rectifier 110a, the LED array 190a, the multichannel switch circuit 140a, and the multichannel switch control circuit 150 illustrated in FIG. 2; thus the detailed description thereof will be omitted to avoid redundancy.

However, the filter/rectifier 110a, the LED array 190a, the multichannel switch circuit 140a, and the multichannel switch control circuit 150 may be the LED array 190b, 190c, 190e, or 190g, the multichannel switch circuit 140b, 140c, 140e, 140g, or 240, and the multichannel switch control circuit 250 illustrated in one of FIGS. 7 through 14 and FIGS. 24 and 25.

In the embodiment illustrated in FIG. 29, the switchable fill circuit 420 includes a resistor 421, a capacitor 422, a transistor 423, and first and second diodes D1 and D2. The transistor 423 is implemented as a PMOS transistor but is not restricted thereto.

The resistor 421 may be connected between the first node N1 and the second node N2; the capacitor 422 may be connected between the second node N2 and the ground; and the transistor 423 may be connected between the second node N2 and the third node N3. The gate of the transistor 423 may be connected to the switchable fill control circuit 440. The first diode D1 may be connected with the resistor 421 in parallel between the second node N2 and the first node N1; and the second diode D2 may be connected between the third node N3 and the fourth node N4.

The first node N1 may be connected to the input of the first LED group 191-1 in the LED array 190a; and the fourth node N4 may be connected to the input of one of the other LED groups 191-2 through 191-k in the LED array 190a.

The control unit 430 may be implemented at least one integrated circuit (IC) chip. The transistor 423 may be embedded in the IC chip or may be provided as an external transistor.

FIG. 30 is a circuit diagram for explaining the operation of the LED driving circuit illustrated in FIG. 29 during period 1. FIG. 31 is a schematic waveform diagram for explaining the operation of the LED driving circuit illustrated in FIG. 29 during period 1.

Period 1 is a period in which a first node voltage Vin is greater than a second node voltage Vsw. In other words, as shown in FIG. 31 the voltage Vin of the first node N1 is greater than the voltage Vsw of the second node N2 in period 1.

In period 1, the switchable fill control circuit 440 turns off the transistor 423 of the switchable fill circuit 420.

For instance, the switchable fill control circuit 440 compares the first node voltage Vin with the second node voltage Vsw and turns off the transistor 423 when the first node voltage Vin is greater than the second node voltage Vsw.

Accordingly, two current paths I_{LED1} and I_{C} are formed in period 1, as shown in FIG. 30: one is a first path flowing from the output of AC power, i.e., the filter/rectifier 110a to the LED array 190a; and the other is a path flowing from the output of the filter/rectifier 110a to the capacitor 422 through the resistor 421, i.e., a charge path for charging the capacitor 422. Consequently, the switchable fill circuit 420 supplies the first input current I_{LED1} to the LED array 190a and allows the charge current I_{C} to flow into the capacitor 422 to charge the capacitor 422 in period 1.

In period 1, the second diode D2 prevents current from flowing from the fourth node N4 toward the capacitor 422.

FIG. 32 is a circuit diagram for explaining the operation of the LED driving circuit illustrated in FIG. 29 during period 2. FIG. 31 is a schematic waveform diagram for explaining the operation of the LED driving circuit illustrated in FIG. 29 during period 2.

Period 2 is a period in which the first node voltage Vin is equal to or less than the second node voltage Vsw. In other words, as shown in FIG. 33, the voltage Vin of the first node N1 is equal to or less than the voltage Vsw of the second node N2 in period 2.

In period 2, the switchable fill control circuit 440 turns on the transistor 423 of the switchable fill circuit 420.

For instance, the switchable fill control circuit 440 compares the first node voltage Vin with the second node voltage Vsw and turns on the transistor 423 when the first node voltage Vin is equal to or less than the second node voltage Vsw.

Accordingly, two current paths I_{LED2-1} and I_{LED2-2} are formed in period 2, as shown in FIG. 32: one is a first path flowing from the second node N2 to the LED array 190a through the first diode D1; and the other is a second path flowing from the second node N2 to the GR2 LED group through the second diode D2 and the fourth node N4.

Consequently, the switchable fill circuit 420 provides the second input current I_{LED2-1} for one input of the LED array 190a, i.e., the input of the first LED group 191-1 and provides the third input current I_{LED2-2} for the input of one LED group (e.g., 191-3) among all the LED groups except for the first LED group 191-1 in period 2.

In period 2, the anti-reverse diode 192 prevents the third input current I_{LED2-2}, which is transmitted from the second node N2 to the GR2 LED group through the second diode D2 and the fourth node N4, from flowing into the GR1 LED group.

FIG. 34 is a schematic waveform diagram of LED input voltage and current in a conventional AC direct type LED driving circuit. Referring to FIG. 34, in the conventional AC direct type LED driving circuit, the LED input voltage applied to an input terminal of an LED array may be an arch-shaped periodical signal, as shown in (a) in FIG. 34; and the LED input current of the LED array may be a signal which increases stepwise as the LED input voltage increases and decreases stepwise as the LED input voltage decreases, as shown in (b) in FIG. 34. Meanwhile, as shown in (b) in FIG. 34, there is a period while the LED input current does not flow.

FIG. 35 is a schematic waveform diagram of LED input voltage and current in the LED driving circuit illustrated in FIGS. 30 and 32. In FIG. 34, (a) shows the first node voltage Vin and the second node voltage Vsw; (b) shows the input currents I_{LED1} and I_{LED2-1} flowing in the first path; and (c) shows the input current I_{LED2-2} flowing through the second path.

In comparison between FIGS. 34 and 35, while there is the period during which the input current is not supplied to the LED array in the conventional AC direct type LED driving circuit, the input current is supplied to the LED array through two different paths and there is no period during which the input current is not supplied to the LED array in the LED driving circuit according to some embodiments of the present invention. Accordingly, the flicker of LED lighting is reduced.

While the present invention has been particularly shown and described with reference to exemplary embodiments thereof, it will be understood by those of ordinary skill in the art that various changes in forms and details may be made therein without departing from the spirit and scope of the present invention as defined by the following claims.

### INDUSTRIAL APPLICABILITY

The present invention relates to an LED driving circuit and method and particularly can be used in LED lighting-related industry.

1.-11. (canceled)

12. An alternating current (AC) direct type light emitting diode (LED) driving circuit comprising:
an LED array which comprises first through n-th LED groups connected in series and operates using a phase-cut AC voltage, where “n” is an integer of at least 2; and
a control unit connected with the LED array, the control unit comprising a multichannel switch circuit comprising first though m-th switches connected with the LED array, where “m” is an integer of at least 2; a multichannel switch control circuit configured to selectively close or open each of the first through m-th switches; a phase detector configured to receive the phase-cut rectified voltage, detect duty information indicating a phase-cut rate, and generate a duty detection signal; a phase dimming controller configured to generate a dimming reference voltage in response to the duty detection signal; and an analog dimming unit configured to control brightness of the LED array by controlling current flowing in each of the first through m-th switches based on the dimming reference voltage.

13. The LED driving circuit of claim 12, wherein the control unit further comprises a bleeder circuit configured to allow holding current, which is necessary for an operation of a phase-cut dimmer generating the phase-cut AC voltage, to flow.

14. The LED driving circuit of claim 12, wherein the phase detector comprises a comparator configured to compare a comparison target voltage with a comparison reference voltage to generate the duty detection signal,
wherein the comparison target voltage is based on the phase-cut rectified voltage.

15. The LED driving circuit of claim 12, wherein the phase detector comprises a Schmidt trigger configured to receive a comparison target voltage and generate the duty detection signal,
wherein the comparison target voltage is based on the phase-cut rectified voltage.

16. The LED driving circuit of claim 12, wherein the phase detector comprises a resistor and a Zener diode connected in series between a ground and a node to which the phase-cut rectified voltage is input.

17. The LED driving circuit of claim 12, wherein the phase dimming controller comprises:
a multiplexer configured to multiplex a first reference voltage and a second reference voltage in response to the duty detection signal; and
a low-pass filter configured to perform low-pass filtering on an output of the multiplexer to output the dimming reference voltage.

18. The LED driving circuit of claim 12, wherein the phase dimming controller comprises:
a multiplexer configured to multiplex a first reference voltage and a second reference voltage in response to the duty detection signal;
a sampling switch connected to an output of the multiplexer to be opened or closed in response to a sampling clock signal; and
a low-pass filter configured to perform low-pass filtering on an output of the sampling switch to output the dimming reference voltage.

19. The LED driving circuit of claim 18, wherein the sampling clock signal have a period shorter than a period of the duty detection signal and a first logic level period of the sampling clock signal is shorter than a second logic level period of the sampling clock signal.

20. The LED driving circuit of claim 12, wherein the phase dimming controller generates an N-bit digital code varying with the duty detection signal and converts the digital code into an analog voltage to generate the dimming reference voltage.

21. The LED driving circuit of claim 20, wherein phase dimming controller comprises:
a counter configured to count the number of pulses of an oscillation signal during a first logic level period of the duty detection signal to output the N-bit digital code; and
a digital-to-analog converter configured to select, as the dimming reference voltage, one of voltages obtained by dividing voltages between a first reference voltage and a second reference voltage by 2^{N} according to the N-bit digital code,
wherein the oscillation signal has a period which is ½^{N} of a period of the duty detection signal.

22. The LED driving circuit of claim 21, wherein the phase dimming controller further comprises a pulse generator configured to output a one-shot pulse signal in which a pulse occurs per period of the duty detection signal,
wherein the one-shot pulse signal is used as a reset signal of the counter.

23. The LED driving circuit of claim 12, further comprising:
a rectifier configured to generate a rectified voltage of the phase-cut AC voltage;
a diode connected to the rectifier; and
a valley-fill circuit connected between the diode and the LED array to supply a transformed rectified voltage to the LED array.

24.-27. (canceled)

28. The LED driving circuit of claim 12, wherein the phase dimming controller controls the brightness of the LED array by controlling the dimming reference voltage according to a predetermined dimming profile or a dimming profile controlled according to an algorithm.

29. An alternating current (AC) direct type light emitting diode (LED) driving circuit comprising:
an LED array comprising first through k-th LED groups connected in series, where “k” is an integer of at least 2;
a control unit comprising a plurality of switches connected to the LED array and a switch control circuit which selectively closes or opens the switches; and
a switchable fill circuit configured to receive a rectified voltage of an AC voltage and to supply a current to the LED array,
wherein the switchable fill circuit provides a first input current for an input of the first LED group of the LED array in a first period and provides a second input current for the input of the first LED group of the LED array and a third input current for an input of one of the LED groups except for the first LED group in a second period.

30. The LED driving circuit of claim 29, further comprising a switchable fill control circuit configured to control the switchable fill circuit to operate differently in the first period and the second period.

31. The LED driving circuit of claim 30, wherein the switchable fill circuit comprises:
a resistor connected between a first node and a second node;
a capacitor connected between the second node and a ground;
a transistor connected between the second node and a third node and connected to the switchable fill control circuit;
a first diode connected in parallel with the resistor; and
a second diode connected between the third node and a fourth node,
wherein the first node is connected to the input of the first LED group and the fourth node is connected to an input of a j-th LED group, where “j” is an integer of at least 2 and at most “k”.

32. The LED driving circuit of claim 31, wherein the switchable fill control circuit turns off the transistor in the first period and turns on the transistor in the second period.

33. The LED driving circuit of claim 31, wherein the switchable fill control circuit compares a voltage of the first node with a voltage of the second node, turns off the transistor when the voltage of the first node is greater than the voltage of the second node, and turns on the transistor when the voltage of the first node is equal to or less than the voltage of the second node.

34. The LED driving circuit of claim 31, wherein the LED array further comprises a third diode connected between the input of the j-th LED group and an output of a (j−1)-th LED group.

35. The LED driving circuit of claim 31, wherein the switchable fill circuit allows a charge current to flow to the capacitor in the first period to charge the capacitor.
